(19) United States
(12) Patent Application Publication
(10) Pub. No.: US 2018/0321731 A1
(43) Pub. Date: Nov. 8, 2018

(54) SYSTEM AND METHOD FOR HEURISTICS BASED USER PRESENCE DETECTION FOR POWER MANAGEMENT

(71) Applicant: Dell Products, LP, Round Rock, TX (US)

(72) Inventors: Keith M. Alfano, Austin, TX (US); Karun P. Reddy, Austin, TX (US)

(73) Assignee: Dell Products, LP, Round Rock, TX (US)

(21) Appl. No.: 15/586,271

(22) Filed: May 4, 2017

(51) Int. Cl. G06F 1/32

(52) U.S. Cl. CPC G06F 1/3231; G06F 1/3287; G06F 1/3265; G06F 1/3296; G06F 1/3209

(57) ABSTRACT

An information handling system operating a heuristic user presence based power management system may comprise a video display and a processor operatively connected to a memory, operating an information handling system according to a full power protocol. The processor may execute machine readable executable code instructions of the heuristic user presence based power management system to receive one or more inputs indicating user absence determined based on information gathered by one or more of a plurality of sensor devices, identify a user absence confidence level associated with the one or more inputs indicating user absence in a human absence confidence table stored in the memory, and to initiate a low power protocol after a first preset time period, if the identified user absence confidence level meets a preset low power threshold value. The processor may also execute code instructions of the heuristic user presence based power management system to receive one or more inputs indicating user presence determined based on information gathered by one or more of the plurality of sensor devices, identify a user presence confidence level associated with the one or more inputs indicating user presence in a human presence confidence table stored in the memory, and initiate a full power protocol, if the identified user presence confidence level meets a preset full power threshold value.

### FIELD OF THE DISCLOSURE

The present disclosure generally relates to information handling systems, and more particularly relates to a system for heuristically managing power consumed by an information handling system based on user presence detection.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components, and may include telecommunication, network communication, and video communication capabilities. Further, the information handling system may include power management systems that may be used to operate the information handling system at various power levels including inactive or sleep states, or full power operation.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 illustrates a generalized embodiment of an information handling system according to an embodiment of the present disclosure;

FIG. 2 is a block diagram illustrating a heuristic user presence based power management system according to an embodiment of the present disclosure;

FIG. 3 is a graphical illustration of an absence confidence factor table according to an embodiment of the present disclosure;

FIG. 4 is a graphical illustration of a presence confidence factor table according to an embodiment of the present disclosure;

FIG. 5 is a block diagram illustrating an absence detection protocol according to an embodiment of the present disclosure;

FIG. 6 is a block diagram illustrating a presence detection protocol according to an embodiment of the present disclosure;

FIG. 7 is a flow diagram illustrating a method of setting a low power protocol to initiate according to an embodiment of the present disclosure;

FIG. 8 is a flow diagram illustrating a method of ceasing initiation of a low power protocol according to an embodiment of the present disclosure;

FIG. 9 is a flow diagram illustrating a method of initiating a full power protocol according to an embodiment of the present disclosure; and

FIG. 10 is a flow diagram illustrating a method of initiating a power protocol according to a responsivity profile setting according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Maintaining a decent aggregate battery run time in current systems poses several challenges, particularly for information handling systems incorporating digital video displays. As video displays have evolved, the increase in their power consumption rates has exceeded the rate at which battery capacity has increased as battery technology simultaneously evolves. Administrative management of power consumption within an enterprise or other organization may further be better managed via embodiments of the present disclosure.

Current solutions to power management issues include clumsy power protocols that often over or under correct power consumption when the information handling system is not in use. For example, current operating systems may include power protocols that instruct the system to dim or turn off an attached video display after a preset period of perceived nonuse of the information handling system, despite the fact that the user is still reading or watching content on the video display. This over or under correction is due, in large part, to an inability to accurately gauge or sense the activity of the user at any given time. A system that can more accurately gauge user activity, and thus, more accurately monitor the power needs of the information handling system is needed.

The heuristic user presence based power management system of the present disclosure provides a non-invasive method of combining information gathered from sensor devices in communication with an information handling system to determine when a positively identified authorized user is actively interacting with the information handling system. The sensor devices from which the user presence based power management and security system receives data in embodiments of the present disclosure may include digital cameras, microphones, temperature sensors, accelerometers, GPS location devices, and motion sensors. Digital cameras in embodiments of the present disclosure may include RGB cameras, 3 Dimensional camera arrays, and infrared cameras.

The heuristic user presence based power management system may communicate with each of these sensor devices via a sensor hub application platform interface that receives and analyzes information gathered by the sensor devices. The sensor hub application platform interface in embodiments of the present disclosure may include software or firmware code instructions that perform varying types of data analysis on the information gathered by the sensor devices, including object detection/recognition, object movement detection/recognition, voice recognition and location, and detection of movement of the information handling system itself.

Following analysis of the information gathered by the sensor devices, the sensor hub application platform interface in embodiments of the present disclosure may transmit to the heuristic user presence based power management system a plurality of inputs indicating a user is present nearby the information handling system. For example, the heuristic user presence based power management system in embodiments of the present disclosure may receive inputs indicating an object has been detected nearby, human movement has been detected nearby, a human voice having a location in front of the video display has been detected, and/or the position of the information handling system has changed (indicating a user has picked up and moved an information handling system such as a laptop or tablet computer).

Similarly, following analysis of the information gathered by the sensor devices, the sensor hub application platform interface in embodiments of the present disclosure may transmit to the heuristic user presence based power management system a plurality of inputs indicating a user who was present nearby the information handling system is now absent. For example, the heuristic user presence based power management system in embodiments of the present disclosure may receive inputs indicating no object has been detected nearby, human movement has not been detected nearby, a human voice having a location in front of the video display has not been detected, and/or the keyboard or cursor control device has not been in use.

The heuristic user presence based power management system may use these inputs to more accurately gauge user activity. For example, when a user is reading or viewing the video display without using the keyboard or mouse, the heuristic user presence based power management system may perceive a degree of user inactivity from a lack of input from the keyboard and mouse, but may instruct the system not to dim or turn off an attached video display if it has also received input indicating detection of the user in close proximity to the video display (indicating the user may still be viewing the video display). As another example, the heuristic user presence based power management system may perceive a degree of user presence from detection of an object nearby the information handling system, but may instruct the system not to turn on the video display and operating system if no human motion has been detected, no human voice has been detected and the keyboard and mouse have not shown any activity, indicating the detected object nearby is not the user.

As a further issue, design of the optimal power management method may vary from user to user. For example, a user whose primary use of the information handling system includes writing may prefer a different power management method than a user whose primary use of the information handling system includes reading or viewing media. As described above, current operating systems may include power protocols that instruct the system to dim or turn off an attached video display after a preset period of perceived nonuse of the information handling system, despite the fact that the user is still reading or watching content on the video display. The writing user may not find this power management scheme inconvenient, because she is usually maintaining near-constant contact with the mouse or the keyboard. In contrast, the reading user may find it inconvenient to need to move the mouse or tap the keyboard every few minutes in order to keep the system from turning of the video display. Current solutions to power management may allow each user to change or alter the power protocols in place in order to better suit their needs, but each time those needs change, the power protocols must be reset again. A system is needed that can automatically and heuristically adapt its own power protocols in reaction to user behavior.

The heuristic user presence based power management system of the present disclosure fulfills this need by heuristically and automatically adapting the power protocols for an information handling system in response to user behavior and/or changes in user identification as observed via the plurality of user presence sensing devices with which it interfaces. For example, if the heuristic user presence based power management system detects an indication of user presence, such as identification of the user's voice nearby, the system may reactivate an attached video display from an off state. If the user is simply walking past the information handling system with no intention of using it, the heuristic user presence based power management system may fail to detect any other indications of user presence, and may proceed to turn the video display off again after a preset period of time. If this occurs several times in a thirty minute period say, the heuristic user presence based power management system in the present disclosure may “learn” from its past experiences and consequently only reactivate the video display if it receives another indication of user presence from the plurality of user presence sensing devices, in addition to the identification of the user's voice nearby. In such a way, the heuristic user presence based power management system may automatically and heuristically adapt its own power protocols in reaction to observed user behavior.

Although current power management approaches may allow users to alter preset power protocols and tailor the protocols to each individual user, the ways in which a user may alter the protocols are few. This is due to the fact that power protocols often depend on detection of user presence by only one or two user presence sensing devices, such as a keyboard and a mouse. For example, a current power management approach may allow users to preset the amount of time in which the user does not use the keyboard or mouse that may elapse before the video display is turned off. However, for a user that primarily uses the information handling system for reading, the ability to increase or decrease that amount of time may not significantly solve the problem of the video display turning off while she is reading.

The heuristic user presence based power management system of the present disclosure may also allow users to tailor the power protocols to their specific needs. However, because the heuristic user presence based power management system interfaces with a plurality of user presence sensing devices that provide disparate types of user sensing data, a user may more specifically tailor the power protocols to more accurately reflect their individual needs by altering the sensitivity of the heuristic user presence based power management system to each of these varying types of user sensing data. For example, a user that primarily uses the information handling system for reading may instruct the heuristic user presence based power management system to place more emphasis on detection of user presence via identification of the user by the digital camera, rather than detection of the user via use of the keyboard and mouse. In such a way, the heuristic user presence based power management system provides more options for customization of the power protocols, enabling individual users to more accurately tailor the power protocols to her personal needs.

As an additional problem, protection of computer systems from theft or damage to hardware, software, or information on them, as well as from disruption or misdirection of the services they provide is of growing importance due to the increasing reliance on computer systems and the internet, wireless networks such as Bluetooth and Wi-Fi and the growth of “smart” devices, including smartphones, televisions and tiny devices as part of the Internet of Things. Current computer security solutions control physical access to hardware by requiring each user to positively identify themselves via methods such as keyboard entry of passwords, fingerprint or retinal scanning, and facial or voice recognition. Use of more than one of these security systems may increase security afforded to each user, but may also seem cumbersome to many users. For example, users may be annoyed by a duplicative security measure that requires them to enter a password with a keyboard and provide a fingerprint. A non-invasive and less cumbersome system that combines the functionality of a plurality of security systems is needed.

Aggregation and analysis of input from a plurality of these devices may also allow the heuristic user presence based power management and security system to positively identify a user with more than one security method in a non-invasive and non-cumbersome way. For example, the heuristic user presence based power management and security system may require the user to enter a password with a keyboard, but may also passively and non-invasively identify the user through retinal scanning, or facial or voice recognition. Although this approach combines a plurality of security mechanisms, thus increasing the security of the information handling system, the user does not perceive any security measures in place, other than the typical entry of a password via the keyboard.

The heuristics based user presence based power management system of the present disclosure addresses this issue by locking down an operating system by placing it in a low power protocol when a user absence has been detected, and by initiating passive methods of identifying an authorized user upon detection of user presence, prior to the user approaching the information handling system to enter a password, of undergo a retinal scan or fingerprint scan.

Additionally, the heuristics user presence based power management system of the present disclosure may operate in a “privacy mode” in which it transmits a message to authorized users indicating content is still viewable on the video display after the heuristic based user presence based power management system detects the user has moved away from the information handling system. The heuristics user presence based power management system of the present disclosure may, in such a scenario, also lock down the operating system by placing it in a low power protocol if it receives input from a remotely located user requesting it to do so.

Examples are set forth below with respect to particular aspects of an information handling system for heuristically managing power consumed by an information handling system based on user presence detection.

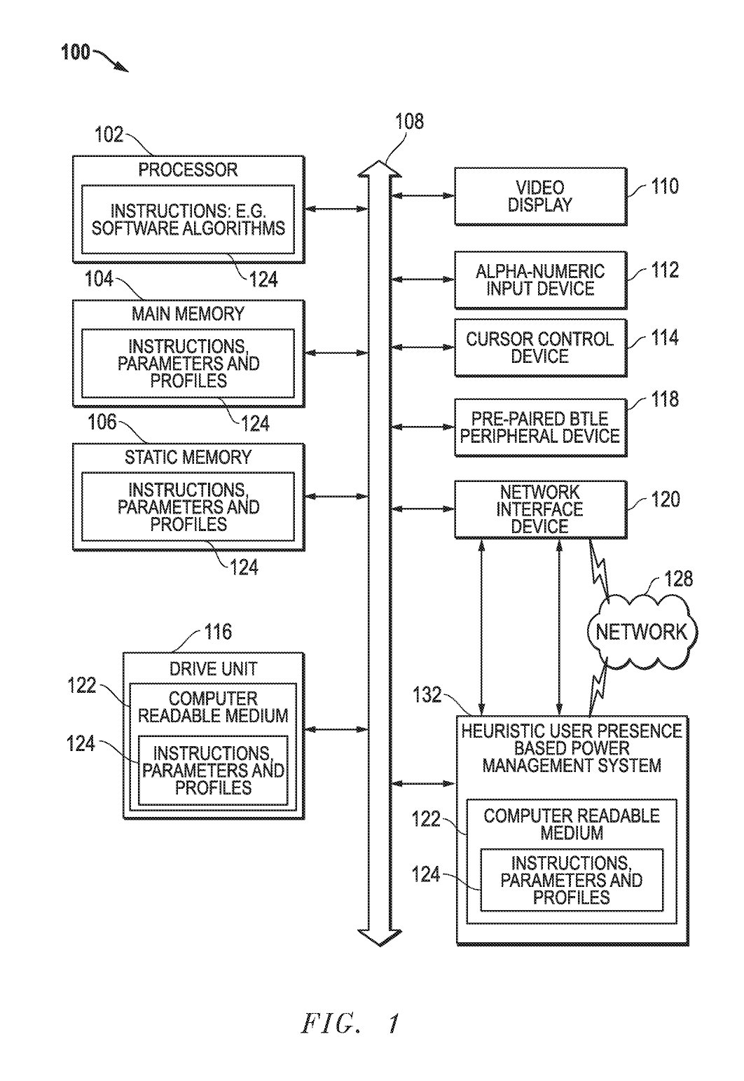

FIG. 1 illustrates an information handling system 100 similar to information handling systems according to several aspects of the present disclosure. For example, an information handling system 100 may be any mobile or other computing device capable of executing a set of instructions (sequential or otherwise) that specify actions to be taken by that machine. In a particular embodiment, the information handling system 100 can be implemented using electronic devices that provide voice, video, or data communication. Further, while a single information handling system 100 is illustrated, the term “system” shall also be taken to include any collection of systems or sub-systems that individually or jointly execute a set, or multiple sets, of instructions to perform one or more computer functions. Specifically, the information handling system 100 may operate on a computing device, on a power adapter operatively connected to a computing device, or on both a computing device and a power adapter operatively connected to a computing device, as described in greater detail below.

Information handling system 100 can include devices or modules that embody one or more of the devices or execute instructions for the one or more systems and modules described above, and operates to perform one or more of the methods described above. The information handling system 100 may execute code instructions 124 that may operate on servers or systems, remote data centers, or on-box in individual client information handling systems according to various embodiments herein. In some embodiments, it is understood any or all portions of code instructions 124 may operate on a plurality of information handling systems 100.

The information handling system 100 may include a processor 102 such as a central processing unit (CPU), control logic or some combination of the same. Any of the processing resources may operate to execute code that is either firmware or software code. Moreover, the information handling system 100 can include memory such as main memory 104, static memory 106, computer readable medium 122 storing instructions 124 of the heuristic user presence based power management system 132, and drive unit 116 (volatile (e.g. random-access memory, etc.), nonvolatile (read-only memory, flash memory etc.) or any combination thereof). The information handling system 100 can also include one or more buses 108 operable to transmit communications between the various hardware components such as any combination of various input and output (I/O) devices. Portions of an information handling system may themselves be considered information handling systems.

As shown, the information handling system 100 may further include a video display 110. The video display 110 in an embodiment may function as a liquid crystal display (LCD), an organic light emitting diode (OLED), a flat panel display, a solid state display, or a cathode ray tube (CRT). Additionally, the information handling system 100 may include an alpha numeric input device 112, such as a keyboard, and a cursor control device 114, such as a mouse, touchpad, or gesture or touch screen input. Further, the information handling system 100 may include a pre-paired Bluetooth low energy (BTLE) peripheral device 118, such as, for example, a Bluetooth wireless keyboard, a Bluetooth wireless mouse, an active Bluetooth wireless printer, a Bluetooth microphone, speaker, or headset, or a separate information handling system connected to the information handling system 100 via Bluetooth connectivity.

Network interface device 120 represents a NIC disposed within information handling system 100, on a main circuit board of the information handling system, integrated onto another component such as processor 102, in another suitable location, or a combination thereof. The network interface device 120 can include another information handling system, a data storage system, another network, a grid management system, another suitable resource, or a combination thereof. Network interface device 120 in an embodiment may operably connect to a network 128. Connection to network 128 may be wired or wireless.

The information handling system 100 can represent a server device whose resources can be shared by multiple client devices, or it can represent an individual client device, such as a desktop personal computer, a laptop computer, a tablet computer, or a mobile phone. In a networked deployment, the information handling system 100 may operate in the capacity of a server or as a client user computer in a server-client user network environment, or as a peer computer system in a peer-to-peer (or distributed) network environment.

The information handling system 100 can include a set of code instructions 124 that can be executed to cause the computer system to perform any one or more of the methods or computer based functions disclosed herein. For example, information handling system 100 includes one or more application programs 124, and Basic Input/Output System and Firmware (BIOS/FW) code instructions 124. BIOS/FW code instructions 124 function to initialize information handling system 100 on power up, to launch an operating system, and to manage input and output interactions between the operating system and the other elements of information handling system 100.

For example, code instructions 124 in an embodiment may be incorporated into an operating system of a computing device, such as Microsoft Windows®. Other example operating systems can include those used with typical mobile computing devices such as Windows Phone or Windows Mobile OS from Microsoft Corporation® and Android OS from Google Inc.®, for example Key Lime Pie v. 5.x. In other embodiments, code instructions 124 may be transmitted from a central location within an enterprise system to a plurality of individual computing devices running operating systems (e.g. Microsoft Windows®) located within the enterprise system network. In both of the above described embodiments, the operating system may have preset power protocols operating on each individual computing device to manage power consumption of the device. For example, the operating system may have preset a low power protocol or sleep state for the computing device that functions to dim or turn off the digital display and to log the user out of the operating system if the operating system does not receive any input indicating user presence for a preset duration of time. As another example, the operating system may have a preset full power protocol or wake state for the computing device that functions to turn on the digital display and either attempt to identify the user or prompt the user for login credentials if the operating system receives input indicating user presence. As yet another example, the operating system may have a preset mid-level power protocol that functions to dim the digital display, present an indication on the digital display that a user absence has been detected, but direct a plurality of sensor devices to scan for signs of user presence.

In a particular embodiment, BIOS/FW code instructions 124 reside in main memory 104, and include machine-executable code that is executed by processor 102 to perform various functions of information handling system 100. Main memory 104 may include, but may not be limited to non-volatile random access memory. In another embodiment, application programs and BIOS/FW code reside in another storage medium of information handling system 100. For example, application programs and BIOS/FW code can reside in static memory 106, drive unit 116, in a ROM (not illustrated) associated with information handling system 100 or other memory. Other options include application programs and BIOS/FW code sourced from remote locations, for example via a hypervisor or other system, that may be associated with various devices of information handling system 100 partially in main memory 104, static memory 106, drive unit 116 or in a storage system (not illustrated) associated with network interface device 120 or any combination thereof. Application programs 124, and BIOS/FW code instructions 124 can each be implemented as single programs, or as separate programs carrying out the various features as described herein. Application program interfaces (APIs) such as Win 32 API may enable application programs 124 to interact or integrate operations with one another.

In an example of the present disclosure, the processor 102 may execute code instructions 124 of the heuristic user presence based power management system 132 as disclosed herein, and an API may enable interaction between the application program and device drivers, a plurality of sensor devices, and other aspects of the information handling system and a heuristic user presence based power management system 132 thereon. The information handling system 100 may operate as a standalone device or may be connected, such as via a network, to other computer systems or peripheral devices. For example, in one embodiment, the information handling system 100 may operate within an individual computing device, such as a laptop, tablet, or desktop computer, and may function to manage power consumption of that device alone. As another example, and in another embodiment, the information handling system 100 may include a network of a plurality of individual computing devices, and the heuristic user presence based power management system 132 may operate to manage power consumption of each of the individual devices within the network. In such an embodiment, an administrator of the network of devices may use the heuristic user presence based power management system 132 to designate a default power management scheme that applies to all of the computing devices within the network, and/or to tailor the power management schemes of one or more of the computing devices within the network according to specific user needs. Further, in such an embodiment, the administrator may be capable of designating a default power management scheme that applies to all of the computing devices, but also allowing a limited ability for each individual user to tailor the power management of their individual computing devices to their own needs.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The heuristic user presence based power management system 132 and the drive unit 116 may include a computer-readable medium 122 such as a magnetic disk in an example embodiment. The computer-readable medium of the main memory 104, static memory 106, drive unit 116, and heuristic user presence based power management system 132 may store one or more sets of code instructions 124, such as software code corresponding to the present disclosure. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The heuristic user presence based power management system 132 computer readable medium 122 may also contain space for data storage. For example, the false reading log may be maintained in computer readable medium 122. As another example, a heuristic table of confidence levels for presence or absence indications may be stored in the computer readable medium 122 of the heuristic user presence based power management system 132. The information handling system 100 may also include a heuristic user presence based power management system 132 that may be operably connected to the bus 108. The heuristic user presence based power management system 132 may perform tasks related to heuristically managing power consumed by an information handling system based on user presence detection. In an embodiment, the heuristic user presence based power management system 132 may communicate with the main memory 104, the processor 102, the video display 110, the alpha-numeric input device 112, and the network interface device 120 via bus 108, and several forms of communication may be used, including ACPI, SMBus, a 24 MHZ BFSK-coded transmission channel, or shared memory.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipset, or other such device, or software capable of operating a relevant environment of the information handling system. The system, device, controller, or module can also include a combination of the foregoing examples of hardware or software. Note that an information handling system can include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

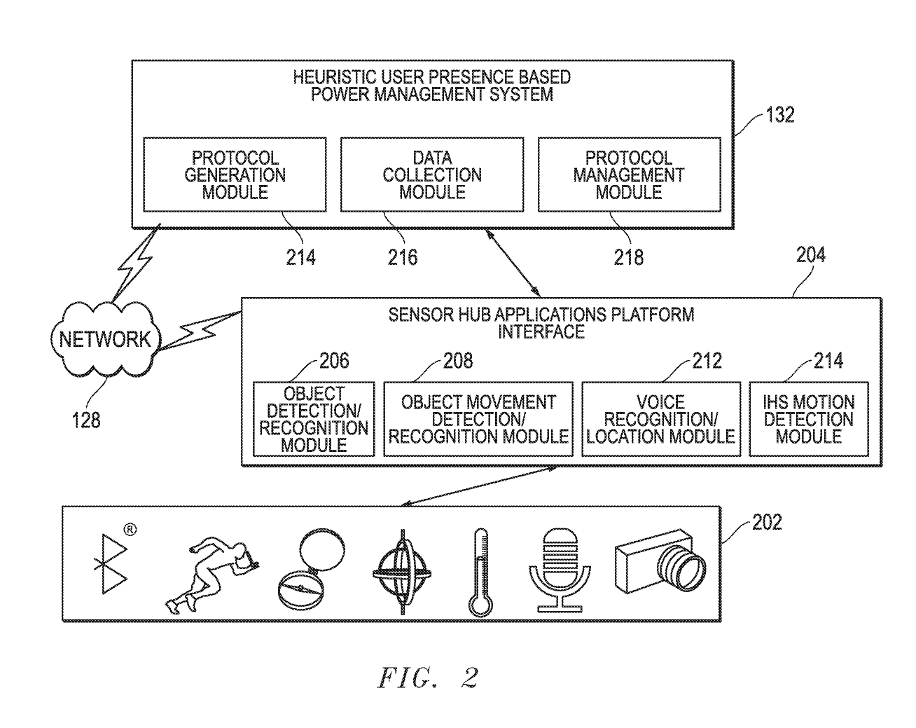

FIG. 2 is a block diagram illustrating a heuristic user presence based power management system communicating with a plurality of sensor devices via a sensor hub application platform interface according to an embodiment of the present disclosure. As described above, the heuristic user presence based power management system in an embodiment may provide a non-invasive method of combining information gathered from a plurality of sensor devices in communication with an information handling system to determine when a positively identified authorized user is actively interacting with the information handling system. As shown in FIG. 2, the sensor devices 202 from which the user presence based power management and security system 132 receives data in embodiments of the present disclosure may include, for example, indication of peripheral wireless devices in wireless communication with a receiver such as Bluetooth®, digital cameras, microphones, temperature sensors, accelerometers, GPS location devices, and motion sensors. These are only a few examples of sensor devices that may be used, and this list is meant to be illustrative rather than limiting. Digital cameras in embodiments of the present disclosure may include RGB cameras, three dimensional camera arrays, infrared cameras, ultrasound sensors as well as other types of cameras capable of gathering information of use in determination of object identification, motion identification, and determination of location of objects nearby the information handling system.

As described above, the information handling system 100 may operate as a standalone device or may be connected, such as via a network, to other computer systems or peripheral devices. For example, in one embodiment, the information handling system 100 may operate within an individual computing device, such as a laptop, tablet, or desktop computer, and may function to manage power consumption of that device alone. In such an embodiment, the sensor devices may be located within the individual computing device, so as to sense the presence of a user of that specific device. As another example, and in another embodiment, the information handling system 100 may include a network of a plurality of individual computing devices, and the heuristic user presence based power management system 132 may operate to manage power consumption of each of the individual devices within the network. In such an embodiment, the sensor devices may be located within each of the plurality of individual computing devices, so as to sense the presence of a user nearby any of the individual computing devices.

As also described above and as shown in FIG. 2, the heuristic user presence based power management system 132 in an embodiment may communicate with each of these sensor devices 202 via a sensor hub application platform interface 204 which may receive and analyze information gathered by the sensor devices 202. The sensor hub application platform interface 204 in embodiments of the present disclosure may include software or firmware code instructions that perform varying types of data analysis on the information gathered by the sensor devices. The present embodiment may have low power operation in determining presence or absence of a user. The heuristic user presence based power management system executes progressively greater power consuming stages in determination of presence or absence where the progressive stages provide added confidence that a user is present or absent. Unless the first few low power sensor stages return a positive that a user is present or absent, the later, higher power consuming stages are not implemented according to some embodiments.

Further, upon reaching a confidence stage threshold level indicating a user presence or absence with respect to an information handling system, a low power protocol may be implemented or entering a low power state of any kind may be averted. The low power protocol may be set by an administrator or an authorized user of the information handling system in various embodiments. An administrator may be concerned with overall power consumption in an enterprise for example. The power savings measures implemented may include several measures under a low power protocol. For example, sleep state activity levels and screen dimming may be activated when an absence is detected with a confidence level or may be avoided if presence is detected. Example measures under a low power protocol may include dimming a video display, dimming a keyboard backlight, turning off one or more radio systems, reducing CPU operation such as turning down CPU frequency, turning off global position systems, sensors, or shutting down peripherals among other measures implemented to save power. One or more of these measures may be turned on at stages or at various confidence levels under the embodiments below. It is understood that any combination of power savings measures is contemplated under a low power protocol under the embodiments of the present disclosure.

The sensor hub applications platform interface 204 in an embodiment may include an object detection recognition module 206 which may function to gather images of the area surrounding the information handling system, taken by a digital camera, and/or temperature readings of the area surrounding the information handling system, observed by a thermal sensor (such as, for example, an infrared camera) and proximity sensors, and analyze those images to determine if a living or human object can be recognized nearby the information handling system. Thermal or infrared cameras systems may gather time of flight data to gauge an object near the sensor or lack of data may indicate an absence. Visual camera systems with time of flight or other determination methods may determine an object is present/absent according to other embodiments. In some embodiments, a three dimensional camera may be available. Additionally, ultrasound sensors and other sensors in the art may be used to establish a object is present or absent according to yet other embodiments.

In some embodiments, one or more of the modules of the sensor hub applications platform interface 204 may assist with auto-focusing of cameras, and measuring short distances between the information handling system and human or non-human objects identified in digital images. The object detection/recognition module 206 in an embodiment may also provide output in the form of a positive or negative identification of a living object located nearby the information handling system. The sensor hub applications platform interface 204 in an embodiment may then communicate that output to the heuristic user presence based power management system 132 in embodiments of the present disclosure, directly or via the network 128, or other form of communication, such as, for example, a communications hub (not shown).

As another example, the sensor hub applications platform interface 204 in an embodiment may include an object movement detection/recognition module 208 which may function to gather images of the area surrounding the information handling system, taken by a digital camera, and/or information gathered by a motion sensor, and analyze those images to determine if the object in motion nearby the information handling system is exhibiting human-like motion. For example, the object movement detection/recognition module 208 may be capable of recognizing human motions such as waving, or sitting down in front of a computing device. The object movement detection/recognition module 208 in an embodiment may also provide output in the form of a positive or negative identification of human movement nearby the information handling system. For example, motion vector analysis may be sued in connection with a pixel movement in images captured with an IR camera, visual camera, or other camera sensors. With motion vector analysis, the object movement detection/recognition module 208 detects pixel movement within an image and may gauge direction and magnitude which may be used to determine gestures or other motion activity indicating a user presence and or distinguishing other movement to confirm absence in some embodiments. The sensor hub applications platform interface 204 in an embodiment may then communicate that output to the heuristic user presence based power management system 132 in embodiments of the present disclosure, via the network 128, or other form of communication, such as, for example, a communications hub (not shown).

As another example, the sensor hub applications platform interface 204 in an embodiment may include a voice recognition/location module 212 which may function to record voices or other noises nearby the information handling system, via one or more microphones, to determine if a detected human voice is located nearby the information handling system, and whether the source of the detected human voice or sound is facing toward the video display. The voice recognition/location module in an embodiment may also provide output in the form of a positive or negative identification of a human voice nearby the information handling system, the specific voice of an authorized user nearby the information handling system, the sound of regular breathing or other activity near the information handling system, and/or the confirmation that the source of the identified human voice is facing the video display of the information handling system. The sensor hub applications platform interface 204 in an embodiment may then communicate that output to the heuristic user presence based power management system 132 in embodiments of the present disclosure, via the network 128, or other form of communication, such as, for example, a communications hub (not shown).

As yet another example, the sensor hub application platform interface 204 in an embodiment may include an information handling system (IHS) motion detection module 214 that may gather positional information from a GPS location device and/or an accelerometer co-located with the information handling system to determine whether the information handling system has changed geographic location or physical orientation, which may indicate that a user has picked up the information handling system (such as, for example, a laptop or tablet computer), and has moved it to another location or orientation. The IHS motion detection module 214 in an embodiment may also provide output in the form of a positive or negative identification of movement of the information handling system, indicating user presence. The sensor hub applications platform interface 204 in an embodiment may then communicate that output to the heuristic user presence based power management system 132 in embodiments of the present disclosure, via the network 128, or other form of communication, such as, for example, a communications hub (not shown).

As described above, the information handling system 100 may operate as a standalone device or may be connected, such as via a network, to other computer systems or peripheral devices. For example, in one embodiment, the information handling system 100 may operate within an individual computing device, such as a laptop, tablet, or desktop computer, and may function to manage power consumption of that device alone. In such an embodiment, the sensor devices may be located within the individual computing device, and the sensor hub application platform interface 204 may be co-located with the sensor devices and heuristic user presence based power management system within the individual computing device.

As another example, and in another embodiment, the information handling system 100 may include a network of a plurality of individual computing devices, and the heuristic user presence based power management system 132 may operate to manage power consumption of each of the individual devices within the network. In such an embodiment, the sensor devices may be located within each of the plurality of individual computing devices, and the sensor hub application platform interface 204 may be either co-located with the sensor devices within the individual computing device and may communicate with the heuristic user presence based power management system via network 128, or may be co-located with the heuristic user presence based power management system and may communicate with the sensor devices via network 128.

As also described above, the heuristic user presence based power management system may use these inputs to more accurately gauge user activity. For example, when a user is reading or viewing the video display without using the keyboard or mouse, the heuristic user presence based power management system may perceive a degree of user inactivity from a lack of input from the keyboard and mouse, but may instruct the system not to dim or turn off an attached video display if it has also received input indicating detection of the user in close proximity to the video display (indicating the user may still be viewing the video display). As another example, the heuristic user presence based power management system may perceive a degree of user presence from detection of an object nearby the information handling system, but may instruct the system not to turn on the video display and operating system if no human motion has been detected, no human voice has been detected and the keyboard and mouse have not shown any activity, indicating the detected object nearby is not the user.

In order to implement these customized schemes for power management based on detection of human presence or human absence, the heuristic user presence based power management system 132 in an embodiment may generate, implement, and heuristically edit one or more power protocols. Each power protocol in an embodiment may dictate the on/off state of the video display, the operating system of the information handling system, and whether the sensor devices 202 are set to periodically and automatically gather information or are set to wait for specific instructions to gather information. As shown in FIG. 2, the heuristic user presence based power management system 132 in an embodiment may include a protocol generation module 214 that may function to generate one or more of these power protocols, and a protocol management module 218 that may function to automatically edit one or more of these power protocols heuristically, and/or may function to interact with the user to allow the user to edit one or more of these power protocols.

As also described, the heuristic user presence based power management system 132 in an embodiment may allow users to tailor power protocols to their specific needs, because it interfaces with a plurality of sensor devices 202 that provide disparate types of user sensing data. Thus, a user may more specifically tailor the power protocols to more accurately reflect their individual needs by altering the sensitivity of the heuristic user presence based power management system 132 to each of these varying types of user sensing data. For example, a user that primarily uses the information handling system for reading may instruct the heuristic user presence based power management system 132 via a graphical user interface to place more emphasis on detection of user presence via identification of the user by the digital camera, rather than detection of the user via use of the keyboard and mouse. Such a graphical user interface may allow for tailoring of the power protocol for an individual computing device by an individual user or may operate to allow an administrator alter the power protocols for a plurality of individual computing devices within an enterprise system. In such a way, the heuristic user presence based power management system 132 provides more options for customization of the power protocols, enabling individual users to more accurately tailor the power protocols to her personal needs.

The heuristic user presence based power management system 132 in an embodiment may determine a spectrum of confidence factors associated with a determination of user presence made based on input from the sensor hub applications platform interface 204. In other words, the heuristic user presence based power management system 132 may receive one or more inputs indicating a user may be present nearby, or absent, and may then determine, based on which inputs were received, how confident the heuristic user presence based power management system 132 is in the overall assessment that the user is either present or absent. In order to implement this customization of power protocols based on the confidence the heuristic user presence based power management system 132 has in the assessment of user presence or absence, the heuristic user presence based power management system 132 in an embodiment may rely on one or more tables stored in memory which associate individual inputs or combinations of inputs indicating user presence or absence with specific human presence or absence confidence factors, as described in greater detail below. By adjusting the confidence associated with each of these inputs, the heuristic user presence based power management system 132 in an embodiment may tailor the power protocols to the behaviors of specific users by placing more emphasis on some inputs to determine user presence than others.

As also described above, the heuristic user presence based power management system 132 in an embodiment may heuristically and automatically adapt the power protocols for an information handling system in response to user behaviors observed via the plurality of sensor devices 202. For example, if the heuristic user presence based power management system 132 detects an indication of user presence, such as identification of the user's voice nearby, the system may reactivate an attached video display from an off state. If the user is simply walking past the information handling system with no intention of using it, the heuristic user presence based power management system 132 may fail to detect any other indications of user presence, and may proceed to turn the video display off again after a preset period of time. If this occurs several times in a thirty minute period say, the heuristic user presence based power management system 132 in an embodiment may “learn” from its past experiences and consequently only reactivate the video display if it receives another indication of user presence from the plurality of sensor devices 202, in addition to the identification of the user's voice nearby. In such a way, the heuristic user presence based power management system 132 may automatically and heuristically adapt its own power protocols in reaction to observed user behavior. In order to implement this heuristic “learning” from its past experiences, the heuristic user presence based power management system may use the data collection module 216 to record past events. For example, the data collection module 216 may include a log of potential false presence or absence readings, as described in greater detail below.

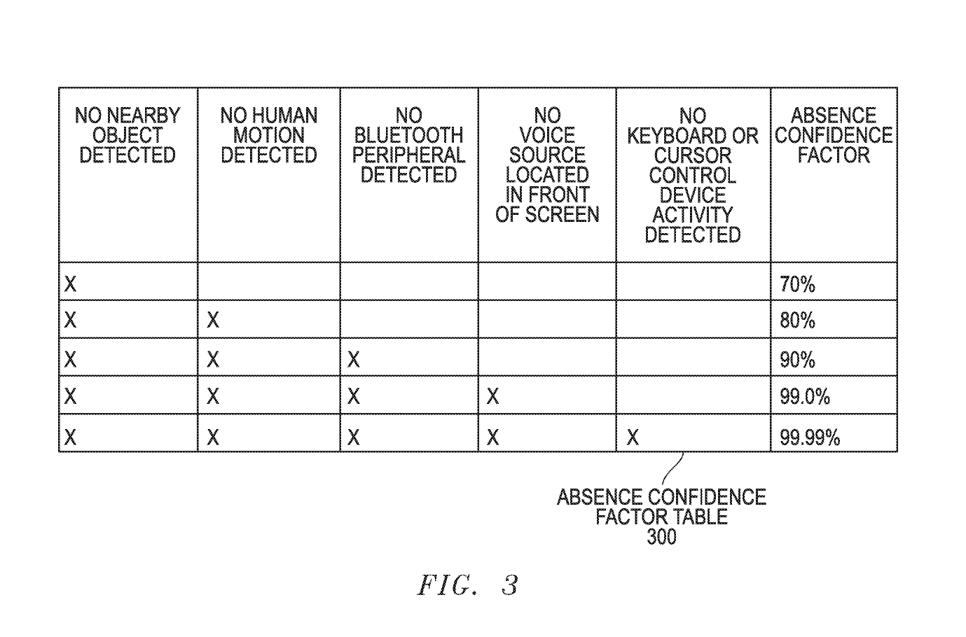

FIG. 3 is a graphical illustration of an absence confidence factor table that assigns absence confidence factors to a plurality of inputs indicating user absence according to an embodiment of the present disclosure. As described above, the heuristic user presence based power management system in an embodiment may allow users to tailor power protocols to their specific needs, because it interfaces with a plurality of sensor devices that provide disparate types of user sensing data. Thus, a user may more specifically tailor the power protocols to more accurately reflect their individual needs by altering the sensitivity of the heuristic user presence based power management system to each of these varying types of user sensing data.

The heuristic user presence based power management system in an embodiment may determine a spectrum of confidence factors associated with a determination of user presence made based on input from the sensor hub applications platform interface. In other words, the heuristic user presence based power management system may receive one or more inputs indicating a user may be absent, and may then determine, based on which inputs were received, how confident the heuristic user presence based power management system is in the overall assessment that the user is absent. In order to implement this customization of power protocols based on the confidence the heuristic user presence based power management system has in the assessment of user absence, the heuristic user presence based power management system in an embodiment may rely on the absence confidence factor table 300 which associates individual inputs or combinations of inputs indicating user absence with specific human absence confidence factors. By adjusting the confidence associated with each of these inputs, the heuristic user presence based power management system 132 in an embodiment may tailor the power protocols to the behaviors of specific users by placing more emphasis on some inputs to determine user presence than others.

As an example, and as shown in FIG. 3, the absence confidence factor table 300 may include a column for each of the disparate types of inputs the heuristic user presence based power management system may receive to indicate the absence of the user, as well as a column for the absence confidence factor associated with each of those inputs. Although the absence confidence factor table 300, as shown in FIG. 3 only includes the inputs indicating that no nearby object has been detected, no human motion has been detected, no Bluetooth peripheral device has been detected, no voice source located in front of the screen has been detected, and no keyboard or cursor control device activity has been detected, this list is meant to be illustrative, rather than limiting, and the absence confidence factor table 300 in other embodiments may further include any number of additional inputs that may indicate user absence. Moreover, the data and confidence factors in FIG. 3 are example data for purposes of illustration and any level of data or variation of factors and data categories are contemplated.

Each row of the absence confidence factor table 300 in an embodiment may indicate which of the inputs indicating user absence is associated with a specific absence confidence factor. For example, the absence confidence factor table 300 may associate the lack of detection of a nearby object, by itself, with an absence confidence factor of 70%. In other words, the heuristic user presence based power management system may associate the single input of no nearby object having been detected with a 70% confidence in the assessment that the user is absent.

The confidence in the assessment that the user is absent may increase as the heuristic user presence based power management system receives more inputs indicating user absence. For example, and as shown in FIG. 3, the absence confidence factor associated with the two inputs including no nearby object having been detected and no human motion having been detected may increase to 80%. As another example, and as shown in FIG. 3, the absence confidence factor associated with the three inputs including no nearby object having been detected, no human motion having been detected, and no Bluetooth peripheral device detected may further increase to 90%. As yet another example, and as shown in FIG. 3, the absence confidence factor associated with the four inputs including no nearby object having been detected, no human motion having been detected, no Bluetooth peripheral device detected, and no voice source located in front of the video display screen having been detected may further increase to 95%. As yet another example, and as shown in FIG. 3, the absence confidence factor associated with the five inputs including no nearby object having been detected, no human motion having been detected, no Bluetooth peripheral device detected, no voice source located in front of the video display screen having been detected, and no keyboard or cursor control device activity having been detected may further increase to 99.99%. Although FIG. 3 only includes five possible combinations of inputs indicating user absence, other embodiments may include many more possible combinations of inputs, each combination being associated with a different absence confident factor.

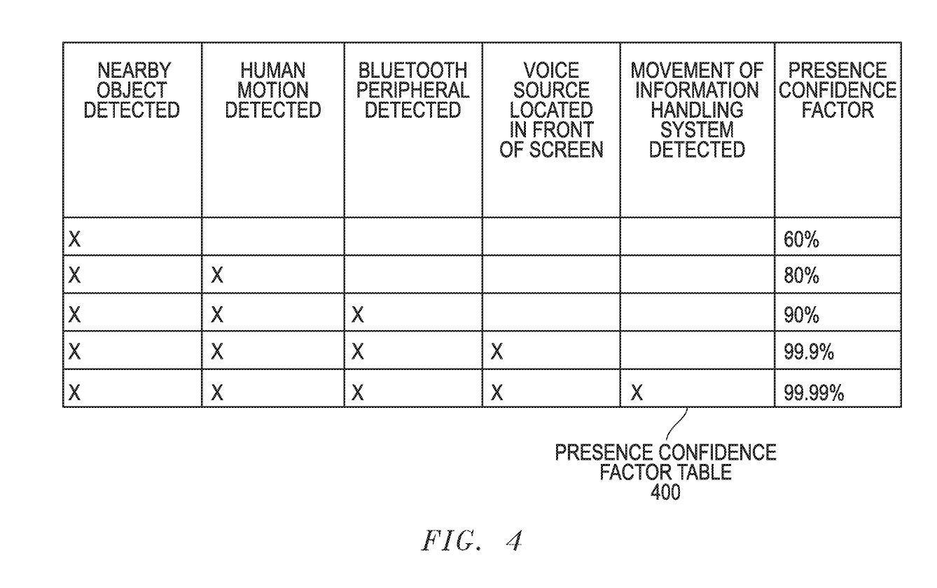

FIG. 4 is a graphical illustration of a presence confidence factor table that assigns presence confidence factors to a plurality of inputs indicating user presence according to an embodiment of the present disclosure. As described above, the heuristic user presence based power management system may receive one or more inputs indicating a user may be present, and may then determine, based on which inputs were received, how confident the heuristic user presence based power management system is in the overall assessment that the user is present. In order to implement this customization of power protocols based on the confidence the heuristic user presence based power management system has in the assessment of user presence, the heuristic user presence based power management system in an embodiment may rely on the presence confidence factor table 400 which associates individual inputs or combinations of inputs indicating user presence with specific human presence confidence factors. The multiple inputs received by the sensors and assessed for presence or absence may be serially combined in an example embodiment in a confidence matrix for a confidence factor table as described herein. The heuristic user presence based power management system executes progressively greater confidence value sensor stages, which may require greater power consumption in stages when determining presence or absence. If the first few stages provide a positive indication or presence or absence, that may not be enough to trigger a change in the power stage implemented. However, later stage sensors may be activated and implemented to reach the confidence needed to trigger a power state change in the information handling system. The later stages may require higher power consumption however to confirm presence or absence. For example, an IR object detection device may be low power relative to activation of a microphone and voice recognition system to determine a higher confidence level as shown in FIG. 3. Similarly, activation of a digital camera system to determine a motion before an information handling system may be less power consuming monitoring than activating motion sensors on the information handling system to determine that no movement has occurred for absence confirmation. By adjusting the confidence associated with each of these inputs, the heuristic user presence based power management system 132 in an embodiment may tailor the power protocols to the behaviors of specific users by placing more emphasis on some inputs to determine user presence than others.

As an example, and as shown in FIG. 4, the presence confidence factor table 400 may include a column for each of the disparate types of inputs the heuristic user presence based power management system may receive to indicate the presence of the user, as well as a column for the presence confidence factor associated with each of those inputs. Although the presence confidence factor table 400, as shown in FIG. 4 only includes the inputs indicating that a nearby object has been detected, human motion has been detected, a Bluetooth peripheral device has been detected, a voice source located in front of the screen has been detected, and movement of the information handling system has been detected, this list is meant to be illustrative, rather than limiting, and the presence confidence factor table 400 in other embodiments may further include any number of additional inputs that may indicate user presence. Moreover, the data and confidence factors in FIG. 4 are example data for purposes of illustration and any level of data or variation of factors and data categories are contemplated.

Each row of the presence confidence factor table 400 in an embodiment may indicate which of the inputs indicating user presence is associated with a specific presence confidence factor. For example, the presence confidence factor table 400 may associate the detection of a nearby object, by itself, with a presence confidence factor of 60%. In other words, the heuristic user presence based power management system may associate the single input of a nearby object having been detected with a 60% confidence in the assessment that the user is present.

The confidence in the assessment that the user is present may increase as the heuristic user presence based power management system receives more inputs indicating user presence. For example, and as shown in FIG. 4, the presence confidence factor associated with the two inputs including a nearby object having been detected and human motion having been detected may increase to 80%. As another example, and as shown in FIG. 4, the presence confidence factor associated with the three inputs including a nearby object having been detected, human motion having been detected, and a Bluetooth peripheral device detected may further increase to 90%. As yet another example, and as shown in FIG. 4, the presence confidence factor associated with the four inputs including a nearby object having been detected, human motion having been detected, a Bluetooth peripheral device detected, and a voice source located in front of the video display screen having been detected may further increase to 95%. As yet another example, and as shown in FIG. 4, the presence confidence factor associated with the five inputs including a nearby object having been detected, human motion having been detected, a Bluetooth peripheral device detected, a voice source located in front of the video display screen having been detected, and movement of the information handling system having been detected may further increase to 99.99%. Although FIG. 4 only includes five possible combinations of inputs indicating user presence, other embodiments may include many more possible combinations of inputs, each combination being associated with a different presence confident factor.

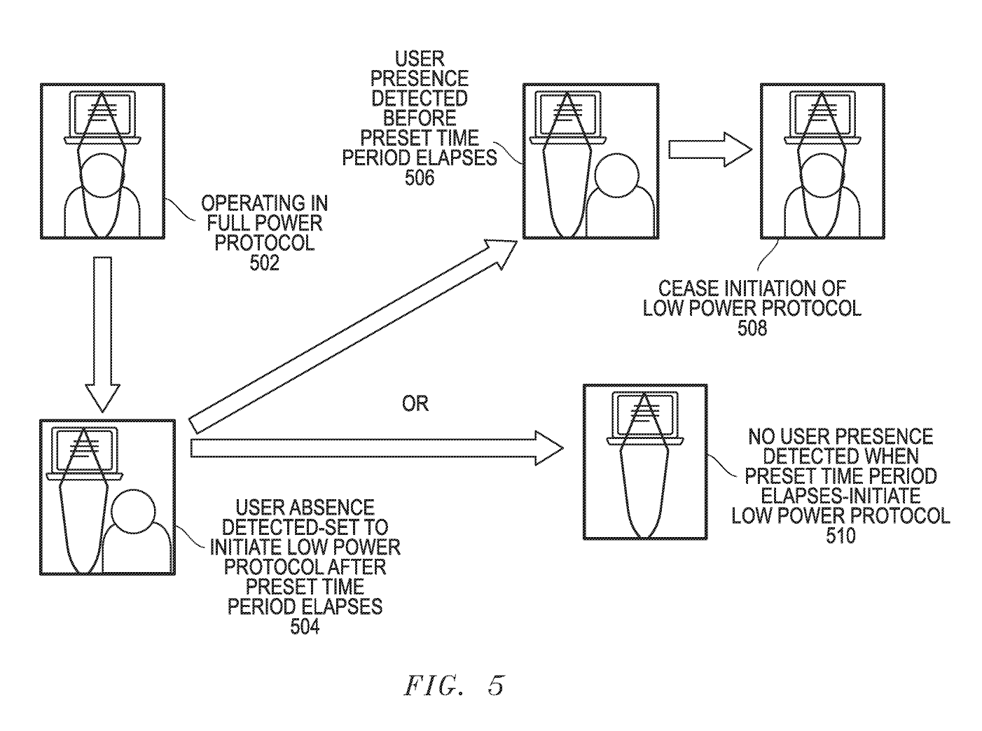

FIG. 5 is a block diagram illustrating a method of initiating a low power protocol after a preset time period when a user absence is detected according to an embodiment of the present disclosure. As described above, the heuristic user presence based power management system in an embodiment may provide a non-invasive method of combining information gathered from a plurality of sensor devices in communication with an information handling system to determine when a positively identified authorized user is actively interacting with the information handling system. The sensor devices from which the user presence based power management and security system may receive data in embodiments of the present disclosure may include, for example, digital cameras, microphones, temperature sensors, accelerometers, GPS location devices, and motion sensors.

As also described above, the heuristic user presence based power management system in an embodiment may communicate with each of these sensor devices via a sensor hub application platform interface which may receive and analyze information gathered by the sensor devices. The sensor hub application platform interface in embodiments of the present disclosure may include software or firmware code instructions that perform varying types of data analysis on the information gathered by the sensor devices, including, but not limited to object detection recognition, object movement detection and recognition, voice recognition and location, and/or information handling system motion detection. The sensor hub applications platform interface in an embodiment may communicate those detected inputs to the heuristic user presence based power management system in embodiments of the present disclosure.

As also described above, the heuristic user presence based power management system may use these inputs to more accurately gauge user activity, and customize the power protocol of the information handling system to respond to the observed user activity. In order to implement these customized schemes for power management based on detection of human presence or human absence, the heuristic user presence based power management system in an embodiment may generate, implement, and heuristically edit one or more power protocols. Each power protocol in an embodiment may dictate the on/off state of the video display, the operating system of the information handling system, and whether the sensor devices are set to periodically and automatically gather information or are set to wait for specific instructions to gather information.

As shown in FIG. 5, at instance 502, an information handling system may be operating according to a full power protocol. A full power protocol may be a power protocol instructing the video display to operate in an on state, instructing the operating system of the information handling system to function in an on state, and instructing a plurality of sensor devices (not shown) to operate in an absence/presence detection protocol, in which the plurality of sensor devices continues to automatically gather information regarding user presence or absence at periodic intervals.

At an instance 504, as shown in FIG. 5, a user absence may be detected. As described above, user absence may be detected based on receipt of one or more inputs such as, for example, a lack of detection of objects nearby the information handling system, no human motion detected nearby, no voice source located nearby, no pre-paired Bluetooth peripheral device detected nearby, and/or inactivity of the keyboard and/or mouse. As shown at instance 504, when user absence has been detected, the heuristic user presence based power management system in an embodiment may set the information handling system to initiate a low power protocol after a preset time period elapses. A low power protocol in an embodiment may include directing the video display to turn off, and directing the operating system to turn off or operate in a sleep or standby mode. The low power protocol in an embodiment may also include directing the plurality of sensor devices to cease intermittent data gathering, gather information less often, or to continue gathering data at the current rate. The preset time period may be any time period set by either the heuristic user presence based power management system or by the user prior to the detection of user absence. For example, the preset time period could be set to five minutes, fifteen minutes, or thirty minutes, depending upon observed user behaviors and/or user preferences.

In other embodiments, the heuristics user presence based power management system may direct the operating system to operate according to a full power protocol despite receipt of one or more inputs indicating user absence. These embodiments include but are not limited to scenarios in which the heuristic user presence based power management system detects the operating system is currently operating code instructions critical to the functionality of the operating system (e.g. OS critical updates), and/or the information handling system is executing code instructions of applications users may view or listen to from a distance, including videos and/or audio playbacks. If the heuristic user presence based power management system in an embodiment determines the operating system is currently executing code instructions involving the playback of videos or audio, and receives an input indicating user absence, it may increase the volume of the playback to accommodate the extended distance between the information handling system and the user. Thus, a user who has moved away from an information handling system and who is not activating a presence detection or is activating an absence detection algorithm may want to continue listening from afar in some embodiments.

The absence detection functionality of the heuristic user presence based power management system may also function as a security feature. For example, by setting the preset time period described directly above to a very short time period, the user may direct the heuristic user presence based power management system to initiate the low power protocol, and lockdown the operating system from unauthorized users nearly immediately after the user absence is detected.

Two separate scenarios may occur following the detection of user absence. First, as shown at instance 506, an input indicating user presence may be received before the preset time period elapses. For example, the user may have stepped away from the information handling system momentarily, and returned to the information handling system before the preset time period of five, fifteen, or thirty minutes elapses. In such a scenario, as shown in instance 508, the heuristic user presence based power management system may cease initiation of the low power protocol, thus remaining in the full power protocol. In such a way, the heuristic user presence based power management system in an embodiment may direct the video display, operating system, and sensor devices to remain active if the user steps away momentarily, then returns quickly.

Also, in such a scenario, the heuristic user presence based power management system may cease initiation of the low power protocol after detecting presence of someone other than an authorized user. In such a way, the heuristic user presence based power management system provides a seamless security aspect to the power saving embodiments herein. The object detection or object motion detection stages may implement facial recognition for example to determine if an object detected before an information handling system sensor is the correct user. For example, Microsoft Windows® Hello may be used to determine if a detected person is the correct person and be implemented by the heuristic user presence based power management system to limit access. Future user recognition techniques may also be used to determine if a person detected before an information handling system is the user authorized for the system during the course of detecting presence/absence under the current embodiments. For example, hand recognition or a particular gesture recognition may be used as well as other biometric recognition techniques in the art or under development. In order to increase security measures, on any occasion in which the heuristic user presence based power management system receives an input indicating user presence during the first preset time period, it may also transmit a message to the authorized user(s) indicating content is still being displayed on the information handling system. The heuristic user presence based power management system in such an embodiment may also consequently initiate immediately the low power protocol in response to user input received from a remote location instructing it to do so.

In another scenario, and as shown in instance 510, no user presence may be detected in an embodiment when the preset time period elapses, indicating the user has stepped away from the information handling system for a longer period of time. In such a scenario, the heuristic user presence based power management system in an embodiment may then initiate the low power protocol, turning off the video display and placing the operating system in an off or inactive state. In such a way, the heuristic user presence based power management system may more accurately gauge the presence or absence of the user, and tailor power consumption of the information handling system to that presence or absence.

Alternatively, at block 508, the heuristics based user presence based power management system of the present disclosure may also increase security by operating in a “privacy mode” in which it transmits a message to authorized users indicating content is still viewable on the video display after the heuristic based user presence based power management system detects the user has moved away from the information handling system. If another, unauthorized user approaches the information handling system at block 508, rather than an authorized user, the remotely located user may transmit an instruction to the heuristics user presence based power management system of the present disclosure to lock down the operating system by placing it in a low power protocol.

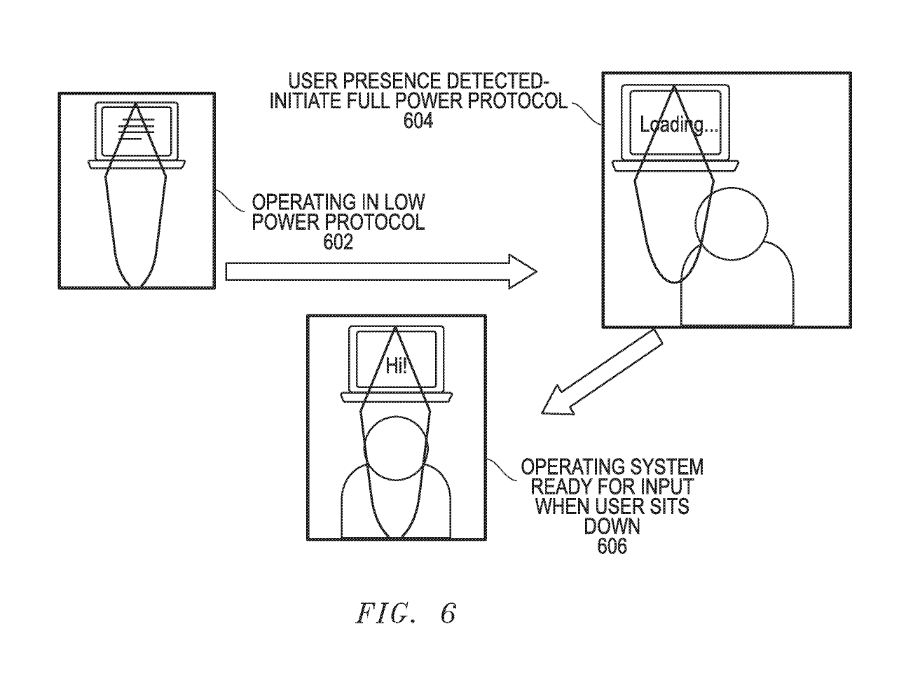

FIG. 6 is a block diagram illustrating a method of initiating a full power protocol when a user presence is detected according to an embodiment of the present disclosure. As described above, the heuristic user presence based power management system in an embodiment may provide a non-invasive method of combining information gathered from a plurality of sensor devices in communication with an information handling system to determine when a positively identified authorized user is actively interacting with the information handling system. As also described above, the heuristic user presence based power management system in an embodiment may communicate with each of these sensor devices via a sensor hub application platform interface which may perform varying types of data analysis on the information gathered by the sensor devices, including, but not limited to object detection recognition, object movement detection and recognition, voice recognition and location, and/or information handling system motion detection. As also described above, the heuristic user presence based power management system may use these inputs to more accurately gauge user activity, and customize the power protocol of the information handling system to respond to the observed user activity by dictating the on/off state of the video display, the operating system of the information handling system, and the sensor devices.

As shown in FIG. 6, at instance 602, an information handling system may be operating according to a low power protocol. As described above, the heuristic user presence based power management system may have directed the information handling system to operate according to a low power protocol in response to detecting a prolonged user absence. As also described above, a low power protocol in an embodiment may include directing the video display to turn off, and directing the operating system to turn off or operate in a sleep or standby mode. The low power protocol in an embodiment may also include directing the plurality of sensor devices to cease intermittent data gathering, gather information less often, or to continue gathering data at the current rate.

At an instance 604, as shown in FIG. 6, a user presence may be detected. As described above, user presence may be detected based on receipt of one or more inputs such as, for example, detection of objects nearby the information handling system, human motion detected nearby, a voice source located nearby, a pre-paired Bluetooth peripheral device detected nearby, and/or movement of the information handling system. As shown at instance 604, when user presence has been detected, the heuristic user presence based power management system in an embodiment may initiate a full power protocol. As described above, a full power protocol in an embodiment may be a power protocol instructing the video display to operate in an on state, instructing the operating system of the information handling system to function in an on state, and instructing a plurality of sensor devices (not shown) to operate in an absence/presence detection protocol, in which the plurality of sensor devices continues to automatically gather information regarding user presence or absence at periodic intervals.

At 606, because the sensor devices (not shown) may detect the user's presence at a distance from the information handling system, the heuristic user presence based power management system may initiate the full power protocol and “waken” or start the operating system such that it has fully booted and is ready for user interaction by the time the user sits down. As described above, the heuristics based user presence based power management system of the present disclosure provides less invasive means of securing the information handling system by initiating passive methods of identifying an authorized user upon detection of user presence, prior to the user approaching the information handling system to enter a password, or undergo a retinal scan or fingerprint scan. For example, in an embodiment, the heuristic user presence based power management system may, upon initiation of full power mode, evoke a Windows “Hello” authentication using a windows RGB and/or infrared camera combined with facial recognition software to log a user in via facial recognition if such a functionality is available, or prompt the user to login via password or fingerprint recognition. In such a way, the heuristic user presence based power management system may more accurately gauge the presence or absence of the user, and tailor power consumption of the information handling system to that presence or absence.

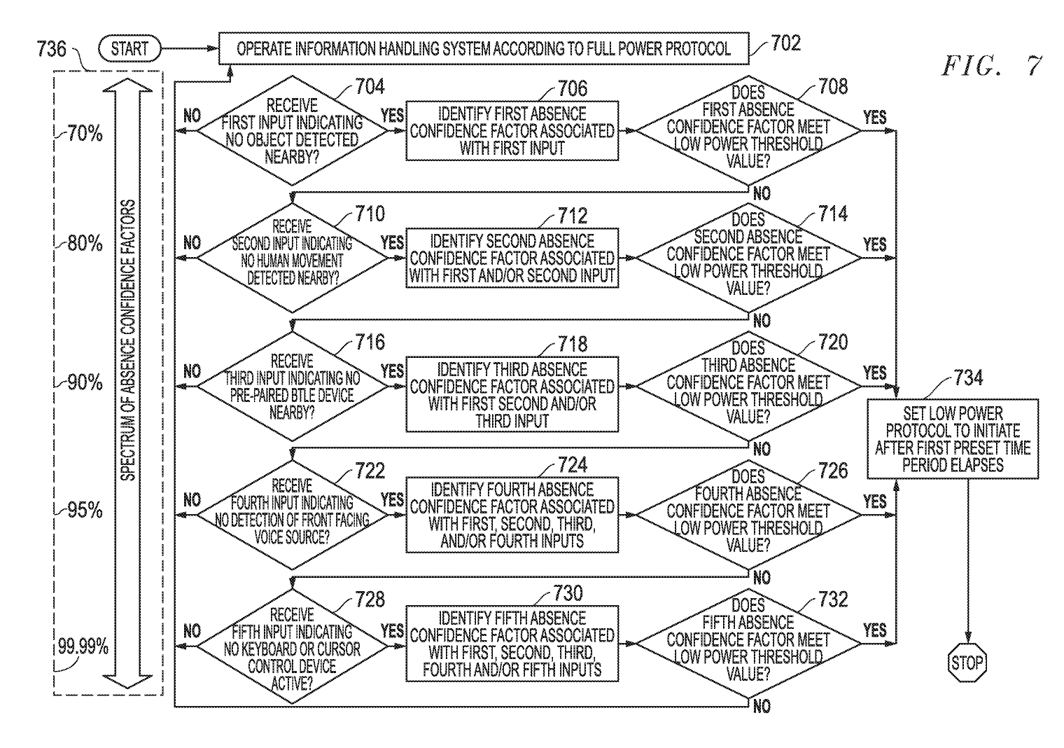

FIG. 7 is a flow diagram illustrating a method of setting a low power protocol to initiate in response to receiving one or more inputs indicating user absence according to an embodiment of the present disclosure. At block 702, in an embodiment, the information handling system may be operating according to a full power protocol. As described above, the heuristic user presence based power management system in an embodiment may provide a non-invasive method of combining information gathered from a plurality of sensor devices in communication with an information handling system to determine when a positively identified authorized user is actively interacting with the information handling system, and to manage power consumed by the information handling system when the user is determined to no longer be using the information handling system. As also described above, a full power protocol in an embodiment may be a power protocol instructing the video display to operate in an on state, instructing the operating system of the information handling system to function in an on state, and instructing a plurality of sensor devices (not shown) to operate in an absence/presence detection protocol, in which the plurality of sensor devices continues to automatically gather information regarding user presence or absence at periodic intervals. At block 702, as shown in FIG. 7, the user may be actively using the information handling system, and the plurality of sensor devices may be gathering sensor information at periodic intervals in order to determine when the user leaves the vicinity of the information handling system or is no longer interacting with the information handling system.

At block 704, in an embodiment, the heuristic user presence based power management system may determine whether a first input indicating no objects have been detected nearby the information handling system has been received. As described above, the heuristic user presence based power management system in an embodiment may communicate with each of a plurality of sensor devices via a sensor hub application platform interface which may receive and analyze information gathered by the sensor devices. The sensor hub application platform interface in embodiments may include software or firmware code instructions that perform varying types of data analysis on the information gathered by the sensor devices, including, but not limited to object detection recognition, object movement detection and recognition, voice recognition and location, and/or information handling system motion detection. The sensor hub applications platform interface in an embodiment may communicate those detected inputs to the heuristic user presence based power management system in embodiments of the present disclosure.

Receipt of a first input indicating user absence, such as the lack of detection of any nearby objects like a human user may indicate the user no longer needs to interact with the information handling system and the heuristic user presence based power management system may initiate a low power protocol to conserve energy. If the heuristic user presence based power management system determines, at block 704, that a first input indicating user absence (e.g. lack of detection of any nearby objects) has been received, the method may proceed to block 706. If the heuristic user presence based power management system determines, at block 704, that a first input indicating user absence has not been received, the heuristic user presence based power management system may treat this lack of user absence as an indication the user is still using the information handling system, and may proceed back to block 702, instructing the information handling system to continue operating according to the full power protocol. Although block 704, as shown in FIG. 7 indicates the first input indicating user absence is a lack of detection of a nearby object, the first input indicating user absence in other embodiments may include any inputs indicating user absence listed in the columns of the user absence confidence factor table described above.

At block 706, in an embodiment, the first absence confidence factor associated with the first input indicating user absence may be identified. As described above, the heuristic user presence based power management system in an embodiment may allow users to tailor power protocols to their specific needs, because it interfaces with a plurality of sensor devices that provide disparate types of user sensing data. Thus, a user may more specifically tailor the power protocols to more accurately reflect their individual needs by altering the sensitivity of the heuristic user presence based power management system to each of these varying types of user sensing data.

As also described above, the heuristic user presence based power management system in an embodiment may determine a spectrum of confidence factors associated with a determination of user presence or absence made based on input from the sensor hub applications platform interface. In other words, the heuristic user presence based power management system may receive one or more inputs indicating a user may be absent, and may then determine, based on which inputs were received, how confident the heuristic user presence based power management system is in the overall assessment that the user is absent. In order to implement this customization of power protocols based on the confidence the heuristic user presence based power management system has in the assessment of user absence, the heuristic user presence based power management system in an embodiment may rely on the absence confidence factor table which associates individual inputs or combinations of inputs indicating user absence with specific human absence confidence factors. By adjusting the confidence associated with each of these inputs, the heuristic user presence based power management system in an embodiment may tailor the power protocols to the behaviors of specific users by placing more emphasis on some inputs to determine user presence than others.

For example, and as shown in FIG. 7, the heuristic user presence based power management system may identify the first absence confidence factor associated with the first input indicating a lack of detection of nearby objects is associated in the absence confidence factor table with an absence confidence factor of only 70%, as reflected in the spectrum of absence confidence factors 736. As described above, although FIG. 7 indicates the first input indicating user absence is a lack of detection of a nearby object, the first input indicating user absence in other embodiments may include any inputs indicating user absence listed in the columns of the user absence confidence factor table described above. Thus, although FIG. 7 indicates the absence confidence factor associated with the first input indicating user absence is 70%, the absence confidence factor associated with the first input indicating user absence in other embodiments may include any absence confidence factor associated with the first input in the absence confidence factor table.

At block 708, in an embodiment, the heuristic user presence based power management system may determine whether the first absence confidence factor meets a low power threshold value. As described above, the confidence in the assessment that the user is absent may increase as the heuristic user presence based power management system receives more inputs indicating user absence. As such, a low power threshold value may be identified and stored in the memory of the information handling system, indicating the absence confidence factor needed in order to set the low power protocol to initiate. In other words, the low power threshold value may dictate the level of confidence in observed user absence that is needed before the heuristic user presence based power management system directs the video display and operating system of the information handling system to turn off. For example, and as shown at block 708 in FIG. 7, the heuristic user presence based power management system may compare the identified 70% absence confidence factor associated with the first input indicating no nearby objects have been detected with the low power threshold value stored in the memory of the information handling system, and determine if the absence confidence factor meets or exceeds the low power threshold value. If the absence confidence factor of 70% meets or exceeds the low power threshold value in an embodiment, the method may proceed to block 734. If the absence confidence factor of 70% does not meet or exceed the low power threshold value in an embodiment, the method may proceed to block 710.

At block 710, in an embodiment, the heuristic user presence based power management system may determine whether a second input indicating no human motion has been detected nearby the information handling system has been received. Receipt of a second input indicating user absence, such as the lack of detection of human movement may indicate the user no longer needs to interact with the information handling system and the heuristic user presence based power management system may initiate a low power protocol to conserve energy. If the heuristic user presence based power management system determines, at block 710, that a second input indicating user absence (e.g. lack of detection of human motion) has been received, the method may proceed to block 712. If the heuristic user presence based power management system determines, at block 710, that a second input indicating user absence has not been received, the heuristic user presence based power management system may treat this lack of user absence as an indication the user is still using the information handling system, and may proceed back to block 702, instructing the information handling system to continue operating according to the full power protocol. Although block 704, as shown in FIG. 7 indicates the first input indicating user absence is a lack of detection of a nearby object, the first input indicating user absence in other embodiments may include any inputs indicating user absence listed in the columns of the user absence confidence factor table described above. Although block 710, as shown in FIG. 7 indicates the second input indicating user absence is a lack of detection of human movement, the second input indicating user absence in other embodiments may include any inputs indicating user absence listed in the columns of the user absence confidence factor table described above.

At block 712, in an embodiment, a second absence confidence factor associated with the first and/or second inputs indicating user absence may be identified. As described above, the heuristic user presence based power management system may receive one or more inputs indicating a user may be absent, and may then determine, based on which inputs were received, how confident the heuristic user presence based power management system is in the overall assessment that the user is absent. In order to implement this customization of power protocols based on the confidence the heuristic user presence based power management system has in the assessment of user absence, the heuristic user presence based power management system in an embodiment may rely on the absence confidence factor table which associates individual inputs or combinations of inputs indicating user absence with specific human absence confidence factors. As also described above, the confidence in the assessment that the user is absent may increase as the heuristic user presence based power management system receives more inputs indicating user absence. For example, the heuristic user presence based power management system may identify a second absence confidence factor of 80% associated with the combination of the first and second inputs indicating user absence, as reflected in the spectrum of absence confidence factors 736.

As described above, although FIG. 7 indicates the first input indicating user absence is a lack of detection of a nearby object, and the second input indicating user absence is a lack of detected human motion, the first and second inputs indicating user absence in other embodiments may include any inputs indicating user absence listed in the columns of the user absence confidence factor table described above. Thus, although FIG. 7 indicates the absence confidence factor associated with the combination of the first and second inputs indicating user absence is 80%, the absence confidence factor associated with the combination of the first and second inputs indicating user absence in other embodiments may include any absence confidence factor associated with the combination of the first and second inputs in the absence confidence factor table.

At block 714, in an embodiment, the heuristic user presence based power management system may determine whether the second absence confidence factor meets the low power threshold value. As described above, the low power threshold value may dictate the level of confidence in observed user absence that is needed before the heuristic user presence based power management system directs the video display and operating system of the information handling system to turn off. For example, and as shown at block 714 in FIG. 7, the heuristic user presence based power management system may compare the identified 80% absence confidence factor associated with the combination of the first and second inputs indicating no nearby objects have been detected and no human motion has been detected with the low power threshold value stored in the memory of the information handling system, and determine if the absence confidence factor meets or exceeds the low power threshold value. If the absence confidence factor of 80% meets or exceeds the low power threshold value in an embodiment, the method may proceed to block 734. If the absence confidence factor of 80% does not meet or exceed the low power threshold value in an embodiment, the method may proceed to block 716.

At block 716, in an embodiment, the heuristic user presence based power management system may determine whether a third input indicating no pre-paired Bluetooth low energy (BTLE) peripheral device has been detected nearby the information handling system has been received. Receipt of a third input indicating user absence, such as the lack of detection of a pre-paired Bluetooth low energy (BTLE) peripheral device may indicate the user no longer needs to interact with the information handling system and the heuristic user presence based power management system may initiate a low power protocol to conserve energy. If the heuristic user presence based power management system determines, at block 716, that a third input indicating user absence (e.g. lack of detection of a pre-paired Bluetooth low energy (BTLE) peripheral device) has been received, the method may proceed to block 718. If the heuristic user presence based power management system determines, at block 716, that a third input indicating user absence has not been received, the heuristic user presence based power management system may treat this lack of user absence as an indication the user is still using the information handling system, and may proceed back to block 702, instructing the information handling system to continue operating according to the full power protocol. Although block 716, as shown in FIG. 7 indicates the third input indicating user absence is a lack of detection of a nearby pre-paired BTLE device, the third input indicating user absence in other embodiments may include any inputs indicating user absence listed in the columns of the user absence confidence factor table described above.

At block 718, in an embodiment, a third absence confidence factor associated with the first, second, and/or third inputs indicating user absence may be identified. As described above, the heuristic user presence based power management system may receive one or more inputs indicating a user may be absent, and may then determine, based on which inputs were received, how confident the heuristic user presence based power management system is in the overall assessment that the user is absent. In order to implement this customization of power protocols based on the confidence the heuristic user presence based power management system has in the assessment of user absence, the heuristic user presence based power management system in an embodiment may rely on the absence confidence factor table described above, which may associate individual inputs or combinations of inputs indicating user absence with specific human absence confidence factors. As also described above, the confidence in the assessment that the user is absent may increase as the heuristic user presence based power management system receives more inputs indicating user absence. For example, the heuristic user presence based power management system may identify a third absence confidence factor of 90% associated with the combination of the first, second, and third inputs indicating user absence, as reflected in the spectrum of absence confidence factors 736.

As described above, although FIG. 7 indicates the first input indicating user absence is a lack of detection of a nearby object, the second input indicating user absence is a lack of detected human motion, and the third input indicating a lack of pre-paired BTLE devices detected nearby, the first, second, and third inputs indicating user absence in other embodiments may include any inputs indicating user absence listed in the columns of the user absence confidence factor table described above. Thus, although FIG. 7 indicates the absence confidence factor associated with the combination of the first, second, and third inputs indicating user absence is 90%, the absence confidence factor associated with the combination of the first, second, and third inputs indicating user absence in other embodiments may include any absence confidence factor associated with the combination of the first, second, and third inputs in the absence confidence factor table.

At block 720, in an embodiment, the heuristic user presence based power management system may determine whether the third absence confidence factor meets the low power threshold value. As described above, the low power threshold value may dictate the level of confidence in observed user absence that is needed before the heuristic user presence based power management system directs the video display and operating system of the information handling system to turn off. For example, and as shown at block 720 in FIG. 7, the heuristic user presence based power management system may compare the identified 90% absence confidence factor associated with the combination of the first, second, and third inputs indicating no nearby objects have been detected, no human motion has been detected, and no nearby pre-paired BTLE devices have been detected with the low power threshold value stored in the memory of the information handling system, and determine if the absence confidence factor meets or exceeds the low power threshold value. If the absence confidence factor of 90% meets or exceeds the low power threshold value in an embodiment, the method may proceed to block 734. If the absence confidence factor of 90% does not meet or exceed the low power threshold value in an embodiment, the method may proceed to block 722.

At block 722, in an embodiment, the heuristic user presence based power management system may determine whether a fourth input indicating no front-facing voice source has been detected nearby the information handling system has been received. Receipt of a fourth input indicating user absence, such as the lack of detection of a front-facing voice source or lack of detection of human voice within a preset distance (e.g. 1.2 meters) of the information handling system, may indicate the user no longer needs to interact with the information handling system and the heuristic user presence based power management system may initiate a low power protocol to conserve energy. If the heuristic user presence based power management system determines, at block 722, that a fourth input indicating user absence (e.g. lack of detection of a front-facing voice source) has been received, the method may proceed to block 724. If the heuristic user presence based power management system determines, at block 722, that a fourth input indicating user absence has not been received, the heuristic user presence based power management system may treat this lack of user absence as an indication the user is still using the information handling system, and may proceed back to block 702, instructing the information handling system to continue operating according to the full power protocol. Although block 722, as shown in FIG. 7 indicates the fourth input indicating user absence is a lack of detection of a voice source facing the video display, the fourth input indicating user absence in other embodiments may include any inputs indicating user absence listed in the columns of the user absence confidence factor table described above.

At block 724, in an embodiment, a fourth absence confidence factor associated with the first, second, third, and/or fourth inputs indicating user absence may be identified. As described above, the heuristic user presence based power management system may receive one or more inputs indicating a user may be absent, and may then determine, based on which inputs were received, how confident the heuristic user presence based power management system is in the overall assessment that the user is absent. In order to implement this customization of power protocols based on the confidence the heuristic user presence based power management system has in the assessment of user absence, the heuristic user presence based power management system in an embodiment may rely on the absence confidence factor table described above, which may associate individual inputs or combinations of inputs indicating user absence with specific human absence confidence factors. As also described above, the confidence in the assessment that the user is absent may increase as the heuristic user presence based power management system receives more inputs indicating user absence. For example, the heuristic user presence based power management system may identify a fourth absence confidence factor of 95% associated with the combination of the first, second, third, and fourth inputs indicating user absence, as reflected in the spectrum of absence confidence factors 736.

As described above, although FIG. 7 indicates the first input indicating user absence is a lack of detection of a nearby object, the second input indicating user absence is a lack of detected human motion, the third input indicating a lack of pre-paired BTLE devices detected nearby, and the fourth input indicating a lack of detection of a voice source facing the video display of the information handling system, the first, second, third, and fourth inputs indicating user absence in other embodiments may include any inputs indicating user absence listed in the columns of the user absence confidence factor table described above. Thus, although FIG. 7 indicates the absence confidence factor associated with the combination of the first, second, third, and fourth inputs indicating user absence is 95%, the absence confidence factor associated with the combination of the first, second, third, and fourth inputs indicating user absence in other embodiments may include any absence confidence factor associated with the combination of the first, second, third, and fourth inputs in the absence confidence factor table.

At block 726, in an embodiment, the heuristic user presence based power management system may determine whether the fourth absence confidence factor meets the low power threshold value. As described above, the low power threshold value may dictate the level of confidence in observed user absence that is needed before the heuristic user presence based power management system directs the video display and operating system of the information handling system to turn off. For example, and as shown at block 726 in FIG. 7, the heuristic user presence based power management system may compare the identified 95% absence confidence factor associated with the combination of the first, second, third, and fourth inputs indicating no nearby objects have been detected, no human motion has been detected, no nearby pre-paired BTLE devices have been detected, and no voice sources facing the video display have been detected with the low power threshold value stored in the memory of the information handling system, and determine if the absence confidence factor meets or exceeds the low power threshold value. If the absence confidence factor of 95% meets or exceeds the low power threshold value in an embodiment, the method may proceed to block 734. If the absence confidence factor of 95% does not meet or exceed the low power threshold value in an embodiment, the method may proceed to block 728.

At block 728, in an embodiment, the heuristic user presence based power management system may determine whether a fifth input indicating no activity of the keyboard or cursor control device has been detected nearby the information handling system has been received. Receipt of a fourth input indicating user absence, such as the lack of detection of activity from the keyboard and/or cursor control device may indicate the user no longer needs to interact with the information handling system and the heuristic user presence based power management system may initiate a low power protocol to conserve energy. If the heuristic user presence based power management system determines, at block 728, that a fourth input indicating user absence (e.g. lack of detection of keyboard or cursor control device activity) has been received, the method may proceed to block 730. If the heuristic user presence based power management system determines, at block 728, that a fourth input indicating user absence has not been received, the heuristic user presence based power management system may treat this lack of user absence as an indication the user is still using the information handling system, and may proceed back to block 702, instructing the information handling system to continue operating according to the full power protocol. Although block 728, as shown in FIG. 7 indicates the fifth input indicating user absence is a lack of detection of keyboard or cursor control device activity, the fifth input indicating user absence in other embodiments may include any inputs indicating user absence listed in the columns of the user absence confidence factor table described above.

At block 730, in an embodiment, a fifth absence confidence factor associated with the first, second, third, fourth, and/or fifth inputs indicating user absence may be identified. As described above, the heuristic user presence based power management system may receive one or more inputs indicating a user may be absent, and may then determine, based on which inputs were received, how confident the heuristic user presence based power management system is in the overall assessment that the user is absent. In order to implement this customization of power protocols based on the confidence the heuristic user presence based power management system has in the assessment of user absence, the heuristic user presence based power management system in an embodiment may rely on the absence confidence factor table described above, which may associate individual inputs or combinations of inputs indicating user absence with specific human absence confidence factors. As also described above, the confidence in the assessment that the user is absent may increase as the heuristic user presence based power management system receives more inputs indicating user absence. For example, the heuristic user presence based power management system may identify a fifth absence confidence factor of 99.99% associated with the combination of the first, second, third, fourth, and fifth inputs indicating user absence, as reflected in the spectrum of absence confidence factors 736.

As described above, although FIG. 7 indicates the first input indicating user absence is a lack of detection of a nearby object, the second input indicating user absence is a lack of detected human motion, the third input indicating a lack of pre-paired BTLE devices detected nearby, the fourth input is a lack of detection of a voice source facing the video display of the information handling system, and the fifth input is a lack of detection of keyboard or cursor control device activity, the first, second, third, fourth, and fifth inputs indicating user absence in other embodiments may include any inputs indicating user absence listed in the columns of the user absence confidence factor table described above. Thus, although FIG. 7 indicates the absence confidence factor associated with the combination of the first, second, third, fourth, and fifth inputs indicating user absence is 99.99%, the absence confidence factor associated with the combination of the first, second, third, fourth, and fifth inputs indicating user absence in other embodiments may include any absence confidence factor associated with the combination of the first, second, third, fourth, and fifth inputs in the absence confidence factor table.

At block 732, in an embodiment, the heuristic user presence based power management system may determine whether the fifth absence confidence factor meets the low power threshold value. As described above, the low power threshold value may dictate the level of confidence in observed user absence that is needed before the heuristic user presence based power management system directs the video display and operating system of the information handling system to turn off. For example, and as shown at block 732 in FIG. 7, the heuristic user presence based power management system may compare the identified 99.99% absence confidence factor associated with the combination of the first, second, third, fourth, and fifth inputs indicating no nearby objects have been detected, no human motion has been detected, no nearby pre-paired BTLE devices have been detected, no voice sources facing the video display have been detected, and no keyboard or cursor control device activity has been detected with the low power threshold value stored in the memory of the information handling system, and determine if the absence confidence factor meets or exceeds the low power threshold value. If the absence confidence factor of 99.99% meets or exceeds the low power threshold value in an embodiment, the method may proceed to block 734. If the absence confidence factor of 99.99% does not meet or exceed the low power threshold value in an embodiment, the method may return to block 702.

At block 734, in an embodiment, the heuristic user presence based power management system in an embodiment may set the low power protocol to initiate after the first preset time period elapses. As described above, when user absence has been detected, the heuristic user presence based power management system in an embodiment may set the information handling system to initiate a low power protocol after a preset time period elapses. A low power protocol in an embodiment may include directing the video display to turn off, and directing the operating system to turn off or operate in a sleep or standby mode. The low power protocol in an embodiment may also include directing the plurality of sensor devices to cease intermittent data gathering, gather information less often, or to continue gathering data at the current rate. The preset time period may be any time period set by either the heuristic user presence based power management system or by the user prior to the detection of user absence. For example, the preset time period could be set to five minutes, fifteen minutes, or thirty minutes, depending upon observed user behaviors and/or user preferences. The absence detection functionality of the heuristic user presence based power management system may also function as a security feature. For example, by setting the preset time period described directly above to a very short time period, the user may direct the heuristic user presence based power management system to initiate the low power protocol, and lockdown the operating system from unauthorized users nearly immediately after the user absence is detected. In such a way, the heuristic user presence based power management system may more accurately gauge the presence or absence of the user, and tailor power consumption of the information handling system to that presence or absence.

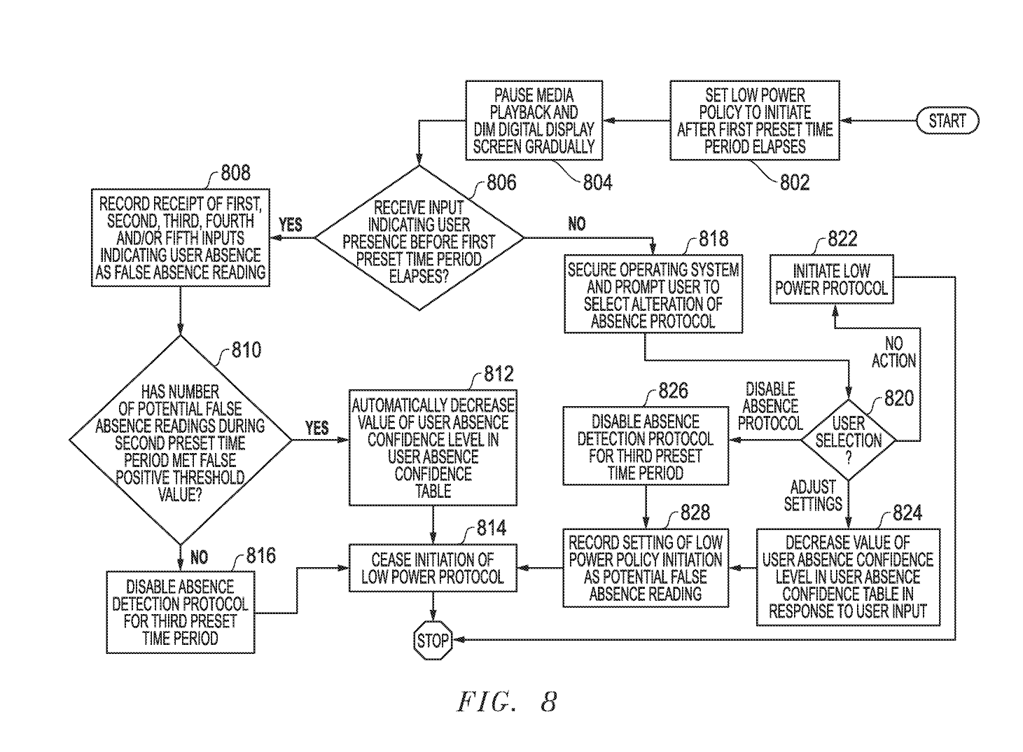

FIG. 8 is a flow diagram illustrating a method of ceasing initiation of a low power protocol in response to receiving an indication that the inputs received, indicating user absence, were false absence readings according to an embodiment of the present disclosure. As described above, and as shown at block 802 in FIG. 8, when user absence has been detected, the heuristic user presence based power management system in an embodiment may set the information handling system to initiate a low power protocol, also referred to as a low power policy, after a preset time period elapses. A low power protocol in an embodiment may include directing the video display to turn off, and directing the operating system to turn off or operate in a sleep or standby mode. The low power protocol in an embodiment may also include directing the plurality of sensor devices to cease intermittent data gathering, gather information less often, or to continue gathering data at the current rate. The preset time period may be any time period set by either the heuristic user presence based power management system or by the user prior to the detection of user absence.

At block 804, in an embodiment, the heuristic user presence based power management system may pause any media playback and dim the digital display screen gradually. These events may indicate to a distracted user that the information handling system is preparing to enter into a low power protocol and may prompt the user to look up, or use a voice command, keyboard command, or cursor control device gesture to indicate she still wishes to interact with the information handling system. Each of these actions on the part of the user may be observed by one or more of the sensor devices, resulting in the heuristic user presence based power management system receiving an input indicating user presence. Alternatively, if the user has left the vicinity of the information handling system or no longer wishes to interact with the information handling system, the sensor devices may not detect any signs of user presence, and the heuristic user presence based power management system consequently may not receive any input indicating user presence.

At block 806, in an embodiment, the heuristic user presence based power management system may determine whether it has received any input indicating user presence, as described directly above, before the first preset time-period elapses. As described above, the preset time period may be any time period set by either the heuristic user presence based power management system or by the user prior to the detection of user absence. For example, the first preset time-period in embodiments may be five minutes, fifteen minutes, or thirty minutes. As also described above, the absence detection functionality of the heuristic user presence based power management system may also function as a security feature. For example, by setting the preset time period described directly above to a very short time period, the user may direct the heuristic user presence based power management system to initiate the low power protocol, and lockdown the operating system from unauthorized users nearly immediately after the user absence is detected.

As also described above, two separate scenarios may occur following the detection of user absence. First, an input indicating user presence may be received before the preset time period elapses. For example, the user may have stepped away from the information handling system momentarily, and returned to the information handling system before the preset time period of five, fifteen, or thirty minutes elapses. In such a scenario, the heuristic user presence based power management system may ultimately cease initiation of the low power protocol, thus remaining in the full power protocol. In such a way, the heuristic user presence based power management system in an embodiment may direct the video display, operating system, and sensor devices to remain active if the user steps away momentarily, then returns quickly. As shown in FIG. 8, at block 806, if the heuristic user presence based power management system receives input indicating user presence before the first preset time period elapses, the method may proceed to block 808.

In another scenario, no user presence may be detected in an embodiment when the preset time period elapses, indicating the user has stepped away from the information handling system for a longer period of time. In such a scenario, the heuristic user presence based power management system in an embodiment may then initiate the low power protocol, turning off the video display and placing the operating system in an off or inactive state. In such a way, the heuristic user presence based power management system may more accurately gauge the presence or absence of the user, and tailor power consumption of the information handling system to that presence or absence. As shown in FIG. 8, at block 806, if the heuristic user presence based power management system does not receive input indicating user presence before the first preset time period elapses, the method may proceed to block 818.

At block 808, in an embodiment, the heuristic user presence based power management system may record the receipt of the first, second, third, fourth, and/or fifth inputs indicating user absence as a false absence reading in a false absence/presence reading log stored in the memory of the information handling system. As described above, the heuristic user presence based power management system may determine whether the fifth absence confidence factor, associated with receipt of the first, second, third, fourth, and/or fifth inputs meets the low power threshold value. As also described above, the low power threshold value may dictate the level of confidence in observed user absence that is needed before the heuristic user presence based power management system directs the video display and operating system of the information handling system to turn off. If the absence confidence factor of meets or exceeds the low power threshold value in an embodiment, the heuristic user presence based power management system in an embodiment may set the low power protocol to initiate after the first preset time period elapses.

However, if the heuristic user presence based power management system receives input indicating user presence before the first preset time period elapses, this may be evidence that the heuristic user presence based power management system misinterpreted the plurality of inputs indicating user absence that led it to initiate the low power protocol. In other words, the one or more inputs indicating user absence the heuristic user presence based power management system received, and that led it to believe the user was absent, may have been false alarms. The heuristic user presence based power management system in an embodiment, as shown at block 808, may record each such false alarm in a false absence/presence reading log in order to later determine whether adjustments to the sensitivity of inputs indicating user absence or presence may be needed, as described in greater detail below.

At block 810, in an embodiment, the heuristic user presence based power management system may determine whether the number of potential false absence readings during a second preset time period meets a false positive threshold value stored in the memory of the information handling system. As described above, the heuristic user presence based power management system in an embodiment may heuristically and automatically adapt the power protocols for an information handling system in response to user behavior and/or changes in user identification as observed over time via the plurality of user presence sensing devices with which it interfaces. For example, if the heuristic user presence based power management system detects an indication of user presence, such as identification of the user's voice nearby, the system may reactivate an attached video display from an off state. If the user is simply walking past the information handling system with no intention of using it, the heuristic user presence based power management system may fail to detect any other indications of user presence, and may proceed to turn the video display off again after a preset period of time. If this occurs several times in a preset time period say, the heuristic user presence based power management system in the present disclosure may “learn” from its past experiences and consequently only reactivate the video display if it receives another indication of user presence from the plurality of user presence sensing devices, in addition to the identification of the user's voice nearby. In such a way, the heuristic user presence based power management system may automatically and heuristically adapt its own power protocols in reaction to observed user behavior.

As also described above, the one or more inputs indicating user absence the heuristic user presence based power management system received, and that led it to believe the user was absent, may have been false alarms. The heuristic user presence based power management system in an embodiment may record each such false alarm in a false absence/presence reading log. If the heuristic user presence based power management system records a plurality of these false alarms during a short time period (e.g. the second preset time period), the sensitivity of the heuristic user presence based power management system to one or more of the inputs that triggered a false alarm may need to be altered in order to more accurately gauge when the user intends to interact with the information handling system.

As shown in FIG. 8, at block 810, if the heuristic user presence based power management system in an embodiment determines the number of potential false absence readings during the second preset time period meets a false positive threshold value stored in the memory of the information handling system, the method may proceed to block 812. Alternatively, and as shown in FIG. 8, at block 810, if the heuristic user presence based power management system in an embodiment determines the number of potential false absence readings during the second preset time period does not meet a false positive threshold value stored in the memory of the information handling system, the method may proceed to block 816. The false positive threshold value and the second preset time period in an embodiment may have any value preset either prior to sale or by the user. For example, the false positive threshold value could be three, and the second preset time period could be thirty minutes. In such an embodiment, if the heuristic user presence based power management system records three “false alarms” during a thirty minute period, it may indicate to the heuristic user presence based power management system that the sensitivity to one or more of the inputs that triggered a false alarm may need to be altered in order to more accurately gauge when the user intends to interact with the information handling system.

At block 816, in an embodiment, the heuristic user presence based power management system may disable the absence protection protocol for a third preset time period. Because the heuristic user presence based power management system at block 816 in an embodiment has not yet initiated the low power protocol, the information handling system may still be operating according to a full power protocol. As described above, the full power protocol may be a power protocol instructing the video display to operate in an on state, instructing the operating system of the information handling system to function in an on state, and instructing a plurality of sensor devices (not shown) to operate in an absence/presence detection protocol, in which the plurality of sensor devices continues to automatically gather information regarding user presence or absence at periodic intervals. However, because the heuristic user presence based power management system has just recorded receipt of a false alarm in absence detection protocol at block 808, and in order to avoid the risk of another false alarm in absence detection recurring quickly, the heuristic user presence based power management system may disable absence detection protocol for a third preset time period at block 816. Disabling absence detection protocol at block 816 in an embodiment may comprise the heuristic user presence based power management system instructing the plurality of sensor devices to temporarily cease gathering information relating to user presence or absence. The third preset time period may have any value preset prior to purchase of the information handling system or preset by the user. For example, the third preset time period may be thirty minutes.

At block 812, in an embodiment, the heuristic user presence based power management system may automatically decrease the value of the user absence confidence level in the user absence confidence table. As described above, if the heuristic user presence based power management system records a preset number “false alarms” during a second preset time period, it may indicate to the heuristic user presence based power management system that the sensitivity to one or more of the inputs that triggered a false alarm may need to be altered in order to more accurately gauge when the user intends to interact with the information handling system. As also described above, by adjusting the absence confidence factor associated with each of the inputs indicating user absence shown in the absence confidence factor table, the heuristic user presence based power management system in an embodiment may tailor the power protocols to the behaviors of specific users by placing more emphasis on some inputs to determine user presence than others.

At block 814, in an embodiment, the heuristic user presence based power management system may initiate cease initiation of the low power protocol. As described above, an input indicating user presence may be received before the preset time period elapses, and the heuristic user presence based power management system may cease initiation of the low power protocol, thus remaining in the full power protocol. For example, the user may have stepped away from the information handling system momentarily, and returned to the information handling system before the preset time period of five, fifteen, or thirty minutes elapses. In such a way, the heuristic user presence based power management system in an embodiment may direct the video display, operating system, and sensor devices to remain active if the user steps away momentarily, then returns quickly. At this point, the flow may stop.

If at block 806, no input indicating user presence is received before the first preset time period elapses, at block 818, in an embodiment, the heuristic user presence based power management system may secure the operating system by logging the user out, and prompt the user to select an alteration of the absence protocol. As described above, the heuristic user presence based power management system of the present disclosure may allow users to tailor the power protocols to their specific needs. Because the heuristic user presence based power management system interfaces with a plurality of user presence sensing devices that provide disparate types of user sensing data, a user may more specifically tailor the power protocols to more accurately reflect their individual needs by altering the sensitivity of the heuristic user presence based power management system to each of these varying types of user sensing data.

At block 820, in an embodiment the heuristic user presence based power management system may receive a user selection in response to the prompt described directly above. As shown in FIG. 8, not receiving a user selection in response to the prompt described directly above, in combination with the previously received one or more inputs indicating user absence may indicate to the heuristic user presence based power management system that the user is not present, and the method may proceed to block 822. If the user does take action in response to this prompt, despite the previously received one or more inputs indicating user absence may indicate to the heuristic user presence based power management system that the user is now present, and that alterations to the sensitivity of the one or more inputs indicating user absence may be needed. If the user chooses to disable the absence protocol, the method may proceed to block 826. If the user chooses to adjust the settings of the heuristic user presence based power management system, the method may proceed to block 824.

If at block 820, the heuristic user presence based power management system receives a user selection to disable the absence protocol, the method may proceed to block 826, then to block 828. At block 826, in an embodiment, the heuristic user presence based power management system may disable the absence detection protocol for a third preset time period. Because the heuristic user presence based power management system at block 826 in an embodiment has not yet initiated the low power protocol, the information handling system may still be operating according to a full power protocol. As described above, the full power protocol may be a power protocol instructing the video display to operate in an on state, instructing the operating system of the information handling system to function in an on state, and instructing a plurality of sensor devices (not shown) to operate in an absence/presence detection protocol, in which the plurality of sensor devices continues to automatically gather information regarding user presence or absence at periodic intervals. However, because the heuristic user presence based power management system has just received user input indicating user presence, and in order to avoid the risk of another false alarm in absence detection recurring quickly, the heuristic user presence based power management system may disable absence detection protocol for a third preset time period. Disabling absence detection protocol in an embodiment may comprise the heuristic user presence based power management system instructing the plurality of sensor devices to temporarily cease gathering information relating to user presence or absence. The third preset time period may have any value preset prior to purchase of the information handling system or preset by the user. For example, the third preset time period may be thirty minutes.

At block 828, in an embodiment, the heuristic user presence based power management system may record the setting of the low power policy initiation as a potential false absence reading. As described above, if the heuristic user presence based power management system receives one or more false alarms indicating user absence several times in a preset time period say, the heuristic user presence based power management system in the present disclosure may “learn” from its past experiences and consequently alter its sensitivities to specific indications of user presence received from the plurality of user presence sensing devices. As also described above, the heuristic user presence based power management system in an embodiment may record each such false alarm in a false absence/presence reading log. Receiving a user selection to disable the absence protocol at block 820 above, despite the previously received one or more inputs indicating user absence, may indicate to the heuristic user presence based power management system that the user is actually present and currently interacting with the information handling system, and that the one or more inputs of user absence that led it to initiate the low power policy were false alarms. Thus, the heuristic user presence based power management system may record the one or more inputs leading to its setting of the low power policy as potential false absence readings in the false absence/presence reading log stored in the memory of the information handling system. At this point, the flow may proceed to block 814, and then may stop.

If at block 820, the heuristic user presence based power management system receives a user selection to adjust settings, the method may proceed to block 824, then to block 828. At block 824, in an embodiment, the heuristic user presence based power management system may decrease the value of the user absence confidence level in the user absence confidence table in response to user input indicating the user wishes to adjust the settings of the system. As described above, by adjusting the absence confidence factor associated with each of the inputs indicating user absence shown in the absence confidence factor table, the user may tailor the power protocols to the behaviors of that specific user by placing more emphasis on some inputs to determine user presence than others. For example, a user that primarily uses the information handling system for reading may instruct the heuristic user presence based power management system to place more emphasis on detection of user presence via identification of the user by the digital camera, rather than detection of the user via use of the keyboard and mouse. In such a way, the heuristic user presence based power management system provides more options for customization of the power protocols, enabling individual users to more accurately tailor the power protocols to her personal needs.

At block 828, in an embodiment, the heuristic user presence based power management system may record the setting of the low power policy initiation as a potential false absence reading. As described above, if the heuristic user presence based power management system receives one or more false alarms indicating user absence several times in a preset time period say, the heuristic user presence based power management system in the present disclosure may “learn” from its past experiences and consequently alter its sensitivities to specific indications of user presence received from the plurality of user presence sensing devices. As also described above, the heuristic user presence based power management system in an embodiment may record each such false alarm in a false absence/presence reading log. Receiving a user selection to adjust the settings at block 820 above, despite the previously received one or more inputs indicating user absence, may indicate to the heuristic user presence based power management system that the user is actually present and currently interacting with the information handling system, and that the one or more inputs of user absence that led it to initiate the low power policy were false alarms. Thus, the heuristic user presence based power management system may record the one or more inputs leading to its setting of the low power policy as potential false absence readings in the false absence/presence reading log stored in the memory of the information handling system. At this point, the flow may proceed to block 814, and then may stop.

If at block 820, the heuristic user presence based power management system does not receive a user selection, the method may proceed to block 822. At block 822, in an embodiment, the heuristic user presence based power management system may initiate the low power protocol. As described directly above, if the user takes no action in response to the prompt, not receiving a user selection in response to the prompt described above, in combination with the previously received one or more inputs indicating user absence may indicate to the heuristic user presence based power management system that the user is not present. The heuristic user presence based power management system in such a scenario may then initiate the low power protocol in order to conserve power. As also described above, a low power protocol in an embodiment may include directing the video display to turn off, and directing the operating system to turn off or operate in a sleep or standby mode. The low power protocol in an embodiment may also include directing the plurality of sensor devices to cease intermittent data gathering, gather information less often, or to continue gathering data at the current rate. At this point, the flow may stop.

Initiation of the low power protocol in an embodiment in response to inputs indicating user absence as observed via the plurality of sensor devices, as described above, may also negate the need for extra parts, such as a Hall Effect Sensor. For clamshell-style notebooks and tablets, an information handling system enclosed in one of these formats may be set to a low power protocol when its lid is closed, triggering an onboard Hall Effect Sensor. However, closing the lid of an information handling system enclosed in a clamshell-style notebook or tablet may also trigger a reading by one or more of the plurality of sensor devices leading to an input indicating user absence. In effect, because the information handling system may rely on these inputs indicating user absence to determine when the lid of the clamshell-style notebook or tablet has been closed, the Hall Effect Sensor may not be needed.

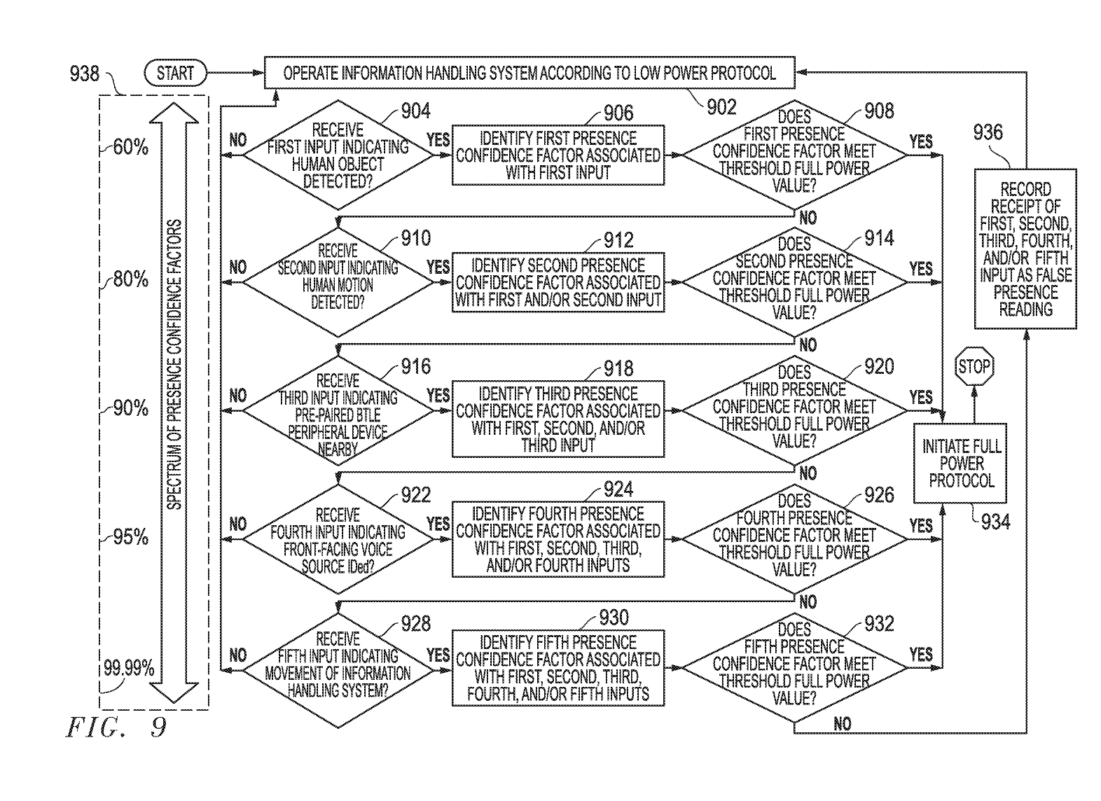

FIG. 9 is a flow diagram illustrating a method of initiating a full power protocol in response to receiving one or more inputs indicating user presence according to an embodiment of the present disclosure. At block 902, in an embodiment, the information handling system may be operating according to a low power protocol. As described above, the heuristic user presence based power management system in an embodiment may provide a non-invasive method of combining information gathered from a plurality of sensor devices in communication with an information handling system to determine when a positively identified authorized user is actively interacting with the information handling system, and to manage power consumed by the information handling system when the user is determined to no longer be using the information handling system. As also described above, a low power protocol in an embodiment may include directing the video display to turn off, and directing the operating system to turn off or operate in a sleep or standby mode. The low power protocol in an embodiment may also include directing the plurality of sensor devices to cease intermittent data gathering, gather information less often, or to continue gathering data at the current rate. In other words, at block 902, as shown in FIG. 9, the user may not be actively using the information handling system, and the plurality of sensor devices may be gathering sensor information at periodic intervals in order to determine when the user returns to the vicinity of the information handling system or is ready to interact with the information handling system.

At block 904, in an embodiment, the heuristic user presence based power management system may determine whether a first input indicating an object has been detected nearby the information handling system has been received. As described above, the heuristic user presence based power management system in an embodiment may communicate with each of a plurality of sensor devices via a sensor hub application platform interface which may receive and analyze information gathered by the sensor devices. The sensor hub application platform interface in embodiments may include software or firmware code instructions that perform varying types of data analysis on the information gathered by the sensor devices, including, but not limited to object detection recognition, object movement detection and recognition, voice recognition and location, and/or information handling system motion detection. The sensor hub applications platform interface in an embodiment may communicate those detected inputs to the heuristic user presence based power management system in embodiments of the present disclosure.

Receipt of a first input indicating user presence, such as detection of a nearby object may indicate the user now needs to interact with the information handling system and the heuristic user presence based power management system may initiate a full power protocol to prepare the information handling system to interact with the user. If the heuristic user presence based power management system determines, at block 904, that a first input indicating user presence (e.g. detection of a nearby object) has been received, the method may proceed to block 906. If the heuristic user presence based power management system determines, at block 904, that a first input indicating user presence has not been received, the heuristic user presence based power management system may treat this lack of user presence as an indication the user still does not need to use the information handling system, and may proceed back to block 902, instructing the information handling system to continue operating according to the low power protocol. Although block 904, as shown in FIG. 9 indicates the first input indicating user presence is a detection of a nearby object, the first input indicating user presence in other embodiments may include any inputs indicating user presence listed in the columns of the user presence confidence factor table described above.

At block 906, in an embodiment, the first presence confidence factor associated with the first input indicating user presence may be identified. As described above, the heuristic user presence based power management system in an embodiment may allow users to tailor power protocols to their specific needs, because it interfaces with a plurality of sensor devices that provide disparate types of user sensing data. Thus, a user may more specifically tailor the power protocols to more accurately reflect their individual needs by altering the sensitivity of the heuristic user presence based power management system to each of these varying types of user sensing data.

As also described above, the heuristic user presence based power management system in an embodiment may determine a spectrum of confidence factors associated with a determination of user presence or absence made based on input from the sensor hub applications platform interface. In other words, the heuristic user presence based power management system may receive one or more inputs indicating a user may be present, and may then determine, based on which inputs were received, how confident the heuristic user presence based power management system is in the overall assessment that the user is present and ready to interact with the information handling system. In order to implement this customization of power protocols based on the confidence the heuristic user presence based power management system has in the assessment of user presence, the heuristic user presence based power management system in an embodiment may rely on the presence confidence factor table which associates individual inputs or combinations of inputs indicating user presence with specific human presence confidence factors. By adjusting the confidence associated with each of these inputs, the heuristic user presence based power management system in an embodiment may tailor the power protocols to the behaviors of specific users by placing more emphasis on some inputs to determine user presence than others.

For example, and as shown in FIG. 9, the heuristic user presence based power management system may identify the first presence confidence factor associated with the first input indicating a detection of nearby objects is associated in the presence confidence factor table with a presence confidence factor of only 60%, as reflected in the spectrum of absence confidence factors 938. As described above, although FIG. 9 indicates the first input indicating user presence is a detection of a nearby object, the first input indicating user presence in other embodiments may include any inputs indicating user presence listed in the columns of the user presence confidence factor table described above. Thus, although FIG. 9 indicates the presence confidence factor associated with the first input indicating user presence is 60%, the presence confidence factor associated with the first input indicating user presence in other embodiments may include any presence confidence factor associated with the first input in the presence confidence factor table.

At block 908, in an embodiment, the heuristic user presence based power management system may determine whether the first presence confidence factor meets a full power threshold value. As described above, the confidence in the assessment that the user is present may increase as the heuristic user presence based power management system receives more inputs indicating user presence. As such, a full power threshold value may be identified and stored in the memory of the information handling system, indicating the presence confidence factor needed in order to set the full power protocol to initiate. In other words, the full power threshold value may dictate the level of confidence in observed user presence that is needed before the heuristic user presence based power management system directs the video display and operating system of the information handling system to turn back on. For example, and as shown at block 908 in FIG. 9, the heuristic user presence based power management system may compare the identified 60% presence confidence factor associated with the first input indicating a nearby object has been detected with the full power threshold value stored in the memory of the information handling system, and determine if the presence confidence factor meets or exceeds the full power threshold value. If the presence confidence factor of 60% meets or exceeds the full power threshold value in an embodiment, the method may proceed to block 934. If the presence confidence factor of 60% does not meet or exceed the low power threshold value in an embodiment, the method may proceed to block 910.

At block 910, in an embodiment, the heuristic user presence based power management system may determine whether a second input indicating human movement has been detected nearby the information handling system has been received. Receipt of a second input indicating user presence, such as detection of human motion may indicate the user now needs to interact with the information handling system and the heuristic user presence based power management system may initiate a full power protocol to prepare the information handling system to interact with the user. If the heuristic user presence based power management system determines, at block 910, that a second input indicating user presence (e.g. detection of human movement) has been received, the method may proceed to block 912. If the heuristic user presence based power management system determines, at block 910, that a second input indicating user presence has not been received, the heuristic user presence based power management system may treat this lack of user presence as an indication the user still does not need to use the information handling system, and may proceed back to block 902, instructing the information handling system to continue operating according to the low power protocol. Although block 910, as shown in FIG. 9 indicates the second input indicating user presence is a detection of human movement, the second input indicating user presence in other embodiments may include any inputs indicating user presence listed in the columns of the user presence confidence factor table described above.

At block 912, in an embodiment, a second presence confidence factor associated with the first and/or second inputs indicating user presence may be identified. As described above, the heuristic user presence based power management system may receive one or more inputs indicating a user may be present, and may then determine, based on which inputs were received, how confident the heuristic user presence based power management system is in the overall assessment that the user is present. In order to implement this customization of power protocols based on the confidence the heuristic user presence based power management system has in the assessment of user presence, the heuristic user presence based power management system in an embodiment may rely on the presence confidence factor table which associates individual inputs or combinations of inputs indicating user presence with specific human presence confidence factors. As also described above, the confidence in the assessment that the user is present may increase as the heuristic user presence based power management system receives more inputs indicating user presence. For example, the heuristic user presence based power management system may identify a second presence confidence factor of 80% associated with the combination of the first and second inputs indicating user presence, as reflected in the spectrum of presence confidence factors 938.

As described above, although FIG. 9 indicates the first input indicating user presence is a detection of a nearby object, and the second input indicating user presence is a detected human motion, the first and second inputs indicating user presence in other embodiments may include any inputs indicating user presence listed in the columns of the user presence confidence factor table described above. Thus, although FIG. 9 indicates the presence confidence factor associated with the combination of the first and second inputs indicating user presence is 80%, the presence confidence factor associated with the combination of the first and second inputs indicating user presence in other embodiments may include any presence confidence factor associated with the combination of the first and second inputs in the presence confidence factor table.

At block 914, in an embodiment, the heuristic user presence based power management system may determine whether the second presence confidence factor meets the full power threshold value. As described above, the full power threshold value may dictate the level of confidence in observed user presence that is needed before the heuristic user presence based power management system directs the video display and operating system of the information handling system to turn on. For example, and as shown at block 914 in FIG. 9, the heuristic user presence based power management system may compare the identified 80% presence confidence factor associated with the combination of the first and second inputs indicating a nearby object has been detected and human motion has been detected with the full power threshold value stored in the memory of the information handling system, and determine if the presence confidence factor meets or exceeds the full power threshold value. If the presence confidence factor of 80% meets or exceeds the full power threshold value in an embodiment, the method may proceed to block 934. If the presence confidence factor of 80% does not meet or exceed the full power threshold value in an embodiment, the method may proceed to block 916.

At block 916, in an embodiment, the heuristic user presence based power management system may determine whether a third input indicating a pre-paired BTLE peripheral device has been detected nearby the information handling system has been received. Receipt of a third input indicating user presence, such as detection of a pre-paired BTLE peripheral device may indicate the user now needs to interact with the information handling system and the heuristic user presence based power management system may initiate a full power protocol to prepare the information handling system to interact with the user. If the heuristic user presence based power management system determines, at block 916, that a third input indicating user presence (e.g. detection of a nearby object) has been received, the method may proceed to block 918. If the heuristic user presence based power management system determines, at block 916, that a third input indicating user presence has not been received, the heuristic user presence based power management system may treat this lack of user presence as an indication the user still does not need to use the information handling system, and may proceed back to block 902, instructing the information handling system to continue operating according to the low power protocol. Although block 916, as shown in FIG. 9 indicates the third input indicating user presence is a detection of a nearby pre-paired BTLE device, the third input indicating user presence in other embodiments may include any inputs indicating user presence listed in the columns of the user presence confidence factor table described above.

At block 918, in an embodiment, a third presence confidence factor associated with the first, second, and/or third inputs indicating user presence may be identified. As described above, the heuristic user presence based power management system may receive one or more inputs indicating a user may be present, and may then determine, based on which inputs were received, how confident the heuristic user presence based power management system is in the overall assessment that the user is present. In order to implement this customization of power protocols based on the confidence the heuristic user presence based power management system has in the assessment of user presence, the heuristic user presence based power management system in an embodiment may rely on the presence confidence factor table described above, which may associate individual inputs or combinations of inputs indicating user presence with specific human presence confidence factors. As also described above, the confidence in the assessment that the user is present may increase as the heuristic user presence based power management system receives more inputs indicating user presence. For example, the heuristic user presence based power management system may identify a third presence confidence factor of 90% associated with the combination of the first, second, and third inputs indicating user presence, as reflected in the spectrum of presence confidence factors 938.

As described above, although FIG. 9 indicates the first input indicating user presence is a detection of a nearby object, the second input indicating user presence is a detected human motion, and the third input is a pre-paired BTLE devices detected nearby, the first, second, and third inputs indicating user presence in other embodiments may include any inputs indicating user presence listed in the columns of the user presence confidence factor table described above. Thus, although FIG. 9 indicates the presence confidence factor associated with the combination of the first, second, and third inputs indicating user presence is 90%, the presence confidence factor associated with the combination of the first, second, and third inputs indicating user presence in other embodiments may include any presence confidence factor associated with the combination of the first, second, and third inputs in the presence confidence factor table.

At block 920, in an embodiment, the heuristic user presence based power management system may determine whether the third presence confidence factor meets the full power threshold value. As described above, the full power threshold value may dictate the level of confidence in observed user presence that is needed before the heuristic user presence based power management system directs the video display and operating system of the information handling system to turn off. For example, and as shown at block 920 in FIG. 9, the heuristic user presence based power management system may compare the identified 90% presence confidence factor associated with the combination of the first, second, and third inputs indicating a nearby object has been detected, human motion has been detected, and one or more nearby pre-paired BTLE devices have been detected with the full power threshold value stored in the memory of the information handling system, and determine if the presence confidence factor meets or exceeds the full power threshold value. If the presence confidence factor of 90% meets or exceeds the full power threshold value in an embodiment, the method may proceed to block 934. If the presence confidence factor of 90% does not meet or exceed the full power threshold value in an embodiment, the method may proceed to block 922.

At block 922, in an embodiment, the heuristic user presence based power management system may determine whether a fourth input indicating a front-facing voice source has been detected has been received. Receipt of a fourth input indicating user presence, such as detection of a front-facing voice source or detection of a voice source within a preset distance (e.g. 1.2 meters) of the information handling system, may indicate the user now needs to interact with the information handling system and the heuristic user presence based power management system may initiate a full power protocol to prepare the information handling system to interact with the user. If the heuristic user presence based power management system determines, at block 922, that a fourth input indicating user presence (e.g. detection of a front-facing voice source) has been received, the method may proceed to block 924. If the heuristic user presence based power management system determines, at block 922, that a fourth input indicating user presence has not been received, the heuristic user presence based power management system may treat this lack of user presence as an indication the user still does not need to use the information handling system, and may proceed back to block 902, instructing the information handling system to continue operating according to the low power protocol. Although block 922, as shown in FIG. 9 indicates the fourth input indicating user presence is a detection of a voice source facing the video display, the fourth input indicating user presence in other embodiments may include any inputs indicating user presence listed in the columns of the user presence confidence factor table described above.

At block 924, in an embodiment, a fourth presence confidence factor associated with the first, second, third, and/or fourth inputs indicating user presence may be identified. As described above, the heuristic user presence based power management system may receive one or more inputs indicating a user may be present, and may then determine, based on which inputs were received, how confident the heuristic user presence based power management system is in the overall assessment that the user is present. In order to implement this customization of power protocols based on the confidence the heuristic user presence based power management system has in the assessment of user presence, the heuristic user presence based power management system in an embodiment may rely on the presence confidence factor table described above, which may associate individual inputs or combinations of inputs indicating user presence with specific human presence confidence factors. As also described above, the confidence in the assessment that the user is present may increase as the heuristic user presence based power management system receives more inputs indicating user presence. For example, the heuristic user presence based power management system may identify a fourth presence confidence factor of 95% associated with the combination of the first, second, third, and fourth inputs indicating user presence, as reflected in the spectrum of presence confidence factors 938.

As described above, although FIG. 9 indicates the first input indicating user presence is a detection of a nearby object, the second input indicating user presence is a detected human motion, the third input is one or more pre-paired BTLE devices detected nearby, and the fourth input is a detection of a voice source facing the video display of the information handling system, the first, second, third, and fourth inputs indicating user presence in other embodiments may include any inputs indicating user presence listed in the columns of the user presence confidence factor table described above. Thus, although FIG. 9 indicates the presence confidence factor associated with the combination of the first, second, third, and fourth inputs indicating user presence is 95%, the presence confidence factor associated with the combination of the first, second, third, and fourth inputs indicating user presence in other embodiments may include any presence confidence factor associated with the combination of the first, second, third, and fourth inputs in the presence confidence factor table.

At block 926, in an embodiment, the heuristic user presence based power management system may determine whether the fourth presence confidence factor meets the full power threshold value. As described above, the full power threshold value may dictate the level of confidence in observed user presence that is needed before the heuristic user presence based power management system directs the video display and operating system of the information handling system to turn on. For example, and as shown at block 926 in FIG. 9, the heuristic user presence based power management system may compare the identified 95% presence confidence factor associated with the combination of the first, second, third, and fourth inputs indicating a nearby object has been detected, human motion has been detected, one or more nearby pre-paired BTLE devices have been detected, and a voice source facing the video display has been detected with the full power threshold value stored in the memory of the information handling system, and determine if the presence confidence factor meets or exceeds the full power threshold value. If the presence confidence factor of 95% meets or exceeds the full power threshold value in an embodiment, the method may proceed to block 934. If the presence confidence factor of 95% does not meet or exceed the full power threshold value in an embodiment, the method may proceed to block 928.

At block 928, in an embodiment, the heuristic user presence based power management system may determine whether a fifth input indicating the information handling system has moved has been received. Receipt of a fifth input indicating user presence, such as detection of movement of the information handling system may indicate the user now needs to interact with the information handling system and the heuristic user presence based power management system may initiate a full power protocol to prepare the information handling system to interact with the user. If the heuristic user presence based power management system determines, at block 928, that a fifth input indicating user presence (e.g. detection movement of the information handling system) has been received, the method may proceed to block 930. If the heuristic user presence based power management system determines, at block 928, that a fifth input indicating user presence has not been received, the heuristic user presence based power management system may treat this lack of user presence as an indication the user still does not need to use the information handling system, and may proceed back to block 902, instructing the information handling system to continue operating according to the low power protocol. Although block 928, as shown in FIG. 7 indicates the fifth input indicating user presence is a detection of movement of the information handling system, the fifth input indicating user presence in other embodiments may include any inputs indicating user presence listed in the columns of the user presence confidence factor table described above.

At block 930, in an embodiment, a fifth presence confidence factor associated with the first, second, third, fourth, and/or fifth inputs indicating user presence may be identified. As described above, the heuristic user presence based power management system may receive one or more inputs indicating a user may be present, and may then determine, based on which inputs were received, how confident the heuristic user presence based power management system is in the overall assessment that the user is present. In order to implement this customization of power protocols based on the confidence the heuristic user presence based power management system has in the assessment of user presence, the heuristic user presence based power management system in an embodiment may rely on the presence confidence factor table described above, which may associate individual inputs or combinations of inputs indicating user presence with specific human presence confidence factors. As also described above, the confidence in the assessment that the user is present may increase as the heuristic user presence based power management system receives more inputs indicating user presence. For example, the heuristic user presence based power management system may identify a fifth presence confidence factor of 99.99% associated with the combination of the first, second, third, fourth, and fifth inputs indicating user presence, as reflected in the spectrum of presence confidence factors 938.

As described above, although FIG. 9 indicates the first input indicating user presence is a detection of a nearby object, the second input indicating user presence is a detected human motion, the third input is one or more pre-paired BTLE devices detected nearby, the fourth input is a detection of a voice source facing the video display of the information handling system, and the fifth input is a detection of movement of the information handling system, the first, second, third, fourth, and fifth inputs indicating user presence in other embodiments may include any inputs indicating user presence listed in the columns of the user presence confidence factor table described above. Thus, although FIG. 9 indicates the presence confidence factor associated with the combination of the first, second, third, fourth, and fifth inputs indicating user presence is 99.99%, the presence confidence factor associated with the combination of the first, second, third, fourth, and fifth inputs indicating user presence in other embodiments may include any presence confidence factor associated with the combination of the first, second, third, fourth, and fifth inputs in the presence confidence factor table.

At block 932, in an embodiment, the heuristic user presence based power management system may determine whether the fifth presence confidence factor meets the full power threshold value. As described above, the full power threshold value may dictate the level of confidence in observed user presence that is needed before the heuristic user presence based power management system directs the video display and operating system of the information handling system to turn off. For example, and as shown at block 932 in FIG. 9, the heuristic user presence based power management system may compare the identified 99.99% presence confidence factor associated with the combination of the first, second, third, fourth, and fifth inputs indicating a nearby object has been detected, human motion has been detected, one or more nearby pre-paired BTLE devices have been detected, a voice source facing the video display has been detected, and movement of the information handling system has been detected with the full power threshold value stored in the memory of the information handling system, and determine if the presence confidence factor meets or exceeds the full power threshold value. If the presence confidence factor of 99.99% meets or exceeds the full power threshold value in an embodiment, the method may proceed to block 934. If the presence confidence factor of 99.99% does not meet or exceed the full power threshold value in an embodiment, the method may proceed to block 936.

At block 934, in an embodiment, the heuristic user presence based power management system may set the full power protocol to initiate. As described above, user presence may be detected based on receipt of one or more inputs such as, for example, detection of objects nearby the information handling system, human motion detected nearby, a voice source located nearby, a pre-paired Bluetooth peripheral device detected nearby, and/or movement of the information handling system. Receipt of the one or more received inputs indicating user presence associated with a presence confidence factor that meets a full power threshold value may indicate to the heuristic user presence based power management system that the user needs to interact with the information handling system. As also described above, when user presence has been detected, the heuristic user presence based power management system in an embodiment may initiate a full power protocol in order to allow the user to interact with the information handling system. As described above, a full power protocol in an embodiment may be a power protocol instructing the video display to operate in an on state, instructing the operating system of the information handling system to function in an on state, and instructing a plurality of sensor devices (not shown) to operate in an absence/presence detection protocol, in which the plurality of sensor devices continues to automatically gather information regarding user presence or absence at periodic intervals.

As also described above, the heuristics based user presence based power management system of the present disclosure provides less invasive means of securing the information handling system by initiating passive methods of identifying an authorized user upon detection of user presence, prior to the user approaching the information handling system to enter a password, or undergo a retinal scan or fingerprint scan. For example, in an embodiment, the heuristic user presence based power management system may, upon initiation of the full power protocol, evoke a Windows “Hello” authentication using a windows RGB and/or infrared camera combined with facial recognition software to log a user in via facial recognition if such a functionality is available, or prompt the user to login via password or fingerprint recognition.

At block 936, in an embodiment, the heuristic user presence based power management system may record receipt of the first, second, third, fourth, and/or fifth inputs as a false presence reading within a false absence/presence reading log stored in the memory of the information handling system. As described above, receipt of the one or more received inputs indicating user presence associated with a presence confidence factor that meets a full power threshold value may indicate to the heuristic user presence based power management system that the user needs to interact with the information handling system. In comparison, receipt of one or more received inputs indicating user presence associated with a presence confidence factor that does not meet a full power threshold value may indicate to the heuristic user presence based power management system that the user does not need to interact with the information handling system, and that each of these one or more received inputs indicating user presence were false alarms, or false readings of user presence.

For example, a received input indicating an object has been detected nearby may merely indicate an object other than the user is nearby. As another example, a received input indicating human motion has been detected may merely indicate the user is walking past the information handling system, and does not actually intend to interact with the information handling system. As another example, a received input indicating a front-facing voice has been detected may merely indicate the user is addressing another person standing on the other side of the information handling system, and the user does not actually intend to interact with the information handling system. As yet another example, a received input indicating the information handling system has moved may merely indicate the system has been bumped or nudged by someone other than the user (e.g. the user's cat), and not that the user wishes to interact with the information handling system.

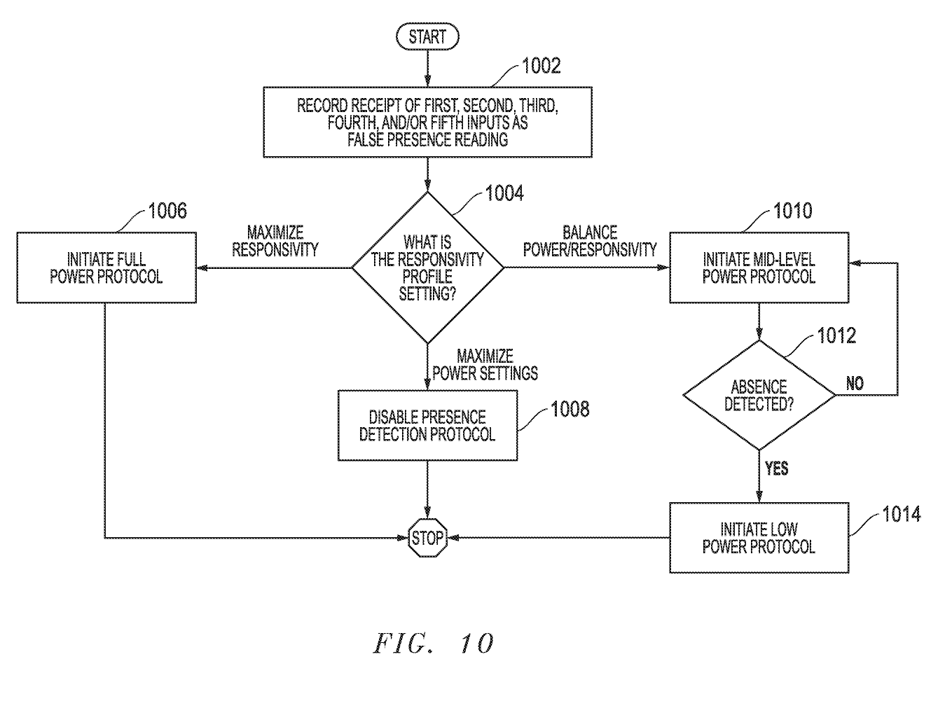

FIG. 10 is a flow diagram illustrating a method of initiating a full power protocol, mid-level power protocol, or low power protocol under a responsivity profile setting according to an embodiment of the present disclosure. As shown in FIG. 10, at block 1002, the heuristic user presence based power management system may record the receipt of a first, second, third, fourth, and/or fifth input such as those described in example embodiments above indicating user presence as a false presence reading. As described above, in an embodiment, the heuristic user presence based power management system may record receipt of a first, second, third, fourth, and/or fifth inputs as a false presence reading within a false absence/presence reading log stored in the memory of the information handling system. As also described above, receipt of the one or more received inputs indicating user presence associated with a presence confidence factor that meets a full power threshold value may indicate to the heuristic user presence based power management system that the user needs to interact with the information handling system. In comparison, receipt of one or more received inputs indicating user presence associated with a presence confidence factor that does not meet a full power threshold value may indicate to the heuristic user presence based power management system that the user does not need to interact with the information handling system, and that each of these one or more received inputs indicating user presence were false alarms, or false readings of user presence.

For example, a received input indicating an object has been detected nearby may merely indicate an object other than the user is nearby. As another example, a received input indicating human motion has been detected may merely indicate the user is walking past the information handling system, and does not actually intend to interact with the information handling system. As another example, a received input indicating a front-facing voice has been detected may merely indicate the user is addressing another person standing on the other side of the information handling system, and the user does not actually intend to interact with the information handling system. As yet another example, a received input indicating the information handling system has moved may merely indicate the system has been bumped or nudged by someone other than the user (e.g. the user's cat), and not that the user wishes to interact with the information handling system.

At block 1004, in an embodiment, the heuristic user presence based power management system may determine the responsivity profile setting. The responsivity profile setting in an embodiment may include one or more options for balancing power consumption and sensitivity of the heuristic user presence based power management system to inputs indicating user presence, and may be stored in the protocol generation module of the heuristic user presence based power management system. The responsivity profile setting in an embodiment may be preset by an individual user in an embodiment, or in another embodiment, may be preset by an administrator of an enterprise system. If the responsivity profile setting is set to maximize system responsivity, which may turn down the power reduction measures, the method may proceed to block 1006. If the responsivity profile setting is set to maximize system power settings for improved power consumption, the method may proceed to block 1008. If the responsivity profile setting is set to balance power and responsivity, the method may proceed to block 1010.

At block 1006, in an embodiment, the heuristic user presence based power management system may initiate the full power protocol. If the heuristic user presence based power management system is set to maximize responsivity, it may prioritize sensitivity to indications of user presence over conservation of power. As a consequence, despite the determination of the heuristic user presence based power management system's determination described above that the one or more received inputs indicating user presence are not associated with a presence confidence factor that meets the full power threshold, the heuristic user presence based power management system may initiate the full power protocol. As described above, the full power protocol may be a power protocol instructing the video display to operate in an on state, instructing the operating system of the information handling system to function in an on state, and instructing a plurality of sensor devices (not shown) to operate in an absence/presence detection protocol, in which the plurality of sensor devices continues to automatically gather information regarding user presence or absence at periodic intervals.

As described above, the heuristics based user presence based power management system of the present disclosure provides less invasive means of securing the information handling system by initiating passive methods of identifying an authorized user upon detection of user presence, prior to the user approaching the information handling system to enter a password, or undergo a retinal scan or fingerprint scan. For example, in an embodiment, the heuristic user presence based power management system may, upon initiation of full power mode, evoke a Windows “Hello” authentication using a windows RGB and/or infrared camera combined with facial recognition software to log a user in via facial recognition if such a functionality is available, or prompt the user to login via password or fingerprint recognition.

At block 1008, in an embodiment, the heuristic user presence based power management system may disable the presence detection protocol. If the heuristic user presence based power management system is set to maximize power settings, it may prioritize conservation of power over sensitivity to indications of user presence. Because the heuristic user presence based power management system has just recorded receipt of a false alarm in presence detection protocol at block 1002, and in order to conserve the power consumed by the sensor devices scanning for detections of user presence, the heuristic user presence based power management system may disable the presence detection protocol for a third preset time period, thus conserving that power. Disabling presence detection protocol in an embodiment may comprise the heuristic user presence based power management system instructing the plurality of sensor devices to temporarily cease gathering information relating to user presence or absence. The third preset time period may have any value preset prior to purchase of the information handling system or preset by the user. For example, the third preset time period may be thirty minutes.

At block 1010, in an embodiment, the heuristic user presence based power management system may initiate a mid-level power protocol if the responsivity profile setting is set to balance power and responsivity. In an embodiment, a mid-level power protocol may be a power protocol instructing the video display to turn off, instructing the operating system of the information handling system to turn off, but instructing a plurality of sensor devices (not shown) to operate in an absence/presence detection protocol, in which the plurality of sensor devices continues to automatically gather information regarding user presence or absence at periodic intervals. In such a way, the heuristic user presence based power management system decreases power consumption by turning off the video display and operating system, but continues to detect potential signs of user absence.

At block 1012, in an embodiment, the heuristic user presence based power management system may determine whether input indicating user absence has been detected. As described above, the heuristic user presence based power management system in an embodiment may be operating in a mid-level power protocol whereby the sensor devices continue to gather input of user absence. If the heuristic user presence based power management system determines input of user absence has been received, the method may proceed to block 1014. If the heuristic user presence based power management system determines input of user absence has not been received, the method may proceed back to block 1010.

At block 1014, in an embodiment, the heuristic user presence based power management system may initiate the low power protocol. Even while operating pursuant to the responsivity profile setting to balance power and responsivity, once the heuristic user presence based power management system receives input of user absence while operating pursuant to the mid-level power protocol, it may proceed to initiate the low power protocol. As described above, a low power protocol in an embodiment may include directing the video display to turn off, and directing the operating system to turn off or operate in a sleep or standby mode. The low power protocol in an embodiment may also include directing the plurality of sensor devices to cease intermittent data gathering, gather information less often, or to continue gathering data at the current rate. In this particular embodiment, the low power protocol may include directing the plurality of sensor devices to cease intermittent data gathering and to thus consume less power.

The blocks of the flow diagrams discussed above, for example, FIGS. 7, 8, 9, and 10 need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system operating a heuristic user presence based power management system comprising:
a video display;
a processor operatively connected to a memory and operating an information handling system according to a full power protocol; and
the processor executing machine readable executable code instructions of the heuristic user presence based power management system to receive one or more inputs indicating user absence determined based on information gathered by one or more of a plurality of sensor devices, identify a user absence confidence level associated with the one or more inputs indicating user absence in a human absence confidence table stored in the memory, and to initiate a low power protocol after a first preset time period if the identified user absence confidence level meets a preset low power threshold value.

2. The information handling system operating the heuristic user presence based power management system of claim 1, wherein the processor is operating an operating system, and the low power protocol comprises placing the video display in an off state, or placing the operating system in an off state.

3. The information handling system operating the heuristic user presence based power management system of claim 1 further comprising:
the processor executing code instructions of the heuristic user presence based power management system to cease initiation of the low power protocol if the processor receives an input indicating user presence before the first preset time period elapses.

4. The information handling system operating the heuristic user presence based power management system of claim 2 further comprising:
the processor executing code instructions of the heuristic user presence based power management system at the beginning of the first preset time period to:
direct the video display to dim a displayed image;
direct the operating system to pause playback of media; or
direct the operating system to display an indication of observed user absence; and
if the processor receives an input indicating user presence before the first preset time period elapses, the processor executing code instructions of the heuristic user presence based power management system to cease initiation of the low power protocol.

5. The information handling system operating the heuristic user presence based power management system of claim 3 further comprising:
the processor executing code instructions of the heuristic user presence based power management system to:
receive an input indicating user presence before the first preset time period elapses;
determine a number of potential false absence readings for a sensor input in the memory meets a preset false positive threshold value; and
decrease the value of the user absence confidence level associated with the sensor input indicating user absence in the human absence confidence table.

6. The information handling system operating the heuristic user presence based power management system of claim 3 further comprising:
the processor executing code instructions of the heuristic user presence based power management system to:
receive a user selection input indicating the user wishes to disable or adjust the settings of the absence protocol after the first preset time period has elapsed;
direct the plurality of sensor devices to cease gathering information if the user selection input indicates the user wishes to disable the absence protocol; and
decrease the value of the user absence confidence level associated with the one or more inputs indicating user absence in the human absence confidence table according to the user selection input if the user selection input indicates the user wishes to adjust the settings of the absence protocol.

7. The information handling system operating the heuristic user presence based power management system of claim 3, wherein the input indicating user presence comprises one or more of detection of current operation of an application identified within a preset list of passive observation applications, detection of execution of an activity critical to the operating system, or a received user input directing the processor not to initiate the low power protocol.

8. An method for managing power of an information handling system based on heuristically detected user presence comprising:
operating an information handling system according to a full power protocol;
receiving one or more inputs indicating user absence determined based on information gathered by one or more of a plurality of sensor devices;
identifying a user absence confidence level associated with the one or more inputs indicating user absence in a human absence confidence table stored in a memory; and
initiating a low power protocol after a first preset time period if the identified user absence confidence level meets a preset low power threshold value.

9. The method for managing power of an information handling system based on heuristically detected user presence of claim 8, wherein the low power protocol comprises placing a video display in an off state or placing the operating system in an off state.

10. The method for managing power of an information handling system based on heuristically detected user presence of claim 8 further comprising:
ceasing initiation of the low power protocol if the processor receives an input indicating user presence before the first preset time period elapses.

11. The method for managing power of an information handling system based on heuristically detected user presence of claim 9 further comprising:
directing the video display to dim a displayed image, directing the operating system to pause playback of media, or directing the operating system to display an indication of observed user absence at the beginning of the first preset time period; and
ceasing initiation of the low power protocol, if the processor receives an input indicating user presence before the first preset time period elapses.

12. The method for managing power of an information handling system based on heuristically detected user presence of claim 10 further comprising:
receiving an input indicating user presence before the first preset time period elapses;
determining a number of potential false absence readings stored in a false absence/presence reading log in the memory meets a preset false positive threshold value; and
automatically decreasing the value of the user absence confidence level associated with the one or more inputs indicating user absence in the human absence confidence table.

13. The method for managing power of an information handling system based on heuristically detected user presence of claim 10 further comprising:
receiving a user selection input indicating the user wishes to disable or adjust the settings of the absence protocol after the first preset time period has elapsed;
directing the plurality of sensor devices to cease gathering information if the user selection input indicates the user wishes to disable the absence protocol; and
decreasing the value of the user absence confidence level associated with the one or more inputs indicating user absence in the human absence confidence table according to the user selection input if the user selection input indicates the user wishes to adjust the settings of the absence protocol.

14. The method for managing power of an information handling system based on heuristically detected user presence of claim 10, wherein the input indicating user presence comprises one or more of detection of current operation of an application identified within a preset list of passive observation applications, detection of execution of an activity critical to the operating system, or a received user input directing the processor not to initiate the low power protocol.

15. An information handling system operating a heuristic user presence based power management system comprising:
a video display;
a plurality of user presence sensors;
a processor operatively connected to a memory and operating the information handling system according to a low power protocol; and
the processor executing machine readable executable code instructions of the heuristic user presence based power management system to receive one or more inputs indicating user presence determined based on information gathered by one or more of a plurality of sensor devices, identify a user presence confidence level associated with the one or more inputs indicating user presence in a human presence confidence table stored in the memory, and initiate a full power protocol, if the identified user presence confidence level meets a preset full power threshold value.

16. The information handling system operating the heuristic user presence based power management system of claim 15, wherein the processor is operating an operating system, and the full power protocol comprises placing the video display in an on state or placing the operating system in an on state.

17. The information handling system operating the heuristic user presence based power management system of claim 15 further comprising:
the processor executing code instructions of the heuristic user presence based power management system to:
determine the user presence confidence level does not meet the preset full power threshold value; and
record receipt of the one or more inputs indicating user presence as a false presence reading in a false absence/presence reading log in the memory.

18. The information handling system operating the heuristic user presence based power management system of claim 17 further comprising:
the processor executing code instructions of the heuristic user presence based power management system to:
determine a responsivity profile setting is set to maximize responsivity; and
initiate the full power protocol.

19. The information handling system operating the heuristic user presence based power management system of claim 17 further comprising:
the processor executing code instructions of the heuristic user presence based power management system to:
determine a responsivity profile setting is set to maximize power settings; and
direct the plurality of sensor devices to cease gathering information.

20. The information handling system operating the heuristic user presence based power management system of claim 17 further comprising:
the processor executing code instructions of the heuristic user presence based power management system to:
determine a responsivity profile setting is set to balance power and responsivity, and
place the operating system in an on state, place the video display in an off state, and place the operating system in an off state if one or more inputs indicating user absence are received.
